(19) United States
(12) Patent Application Publication
(10) Pub. No.: US 2026/0360136 A1
(43) Pub. Date: Nov. 12, 2026

(54) DETECTING COMPLIANCE VIOLATIONS USING ADVANCED COMPUTER VISION AND GENERATIVE ARTIFICIAL INTELLIGENCE

(71) Applicant: EchoTwin AI, Inc., Boca Raton, FL (US)

(72) Inventors: Christopher Carson, Boca Raton, FL (US); Sergey Sukov, Livermore, CA (US); Bo Shen, Fremont, CA (US)

(21) Appl. No.: 19/553,031

(22) Filed: Feb. 27, 2026

Related U.S. Application Data
(60) Provisional application No. 63/770,859, filed on Mar. 12, 2025.

(51) Int. Cl. G06V 10/82; G06Q 30/018; G06Q 50/26; G06V 20/10

(52) U.S. Cl. CPC G06V 10/82; G06Q 30/018; G06Q 50/26; G06V 20/10

(57) ABSTRACT

System, apparatus, article of manufacture, method and/or computer program embodiments are provided for dynamically determining when sensor data collected by an edge device should be processed locally (e.g., at an edge device) or offloaded to a remote cloud system for additional compliance analysis. An example computer-implemented method may include processing sensor data using a multimodal machine learning model configured to identify a compliance-related object within an environment and one or more visual indicators associated with the compliance-related object; detecting a compliance violation associated with the identified compliance-related object based on the identified compliance-related object and the one or more visual indicators; determining context information associated with the detected compliance violation; generating an evidence package comprising at least a portion of the sensor data associated with the detected compliance violation; and determining one or more distributed processing operations for the evidence package based on the context information.

### CROSS-REFERENCE TO RELATED APPLICATIONS

This application claims the benefit of priority to U.S. Provisional Application No. 63/770,859 filed on Mar. 12, 2025, the contents of which are hereby incorporated by reference in their entirety and for all purposes.

### BACKGROUND

### Field

This disclosure is generally related to detecting compliance violations, and more specifically, to determining, when compliance violation detection and/or context analysis processes should be handled locally (e.g., on an edge device) or offloaded to a remote computing system with greater computing capabilities.

### SUMMARY

Provided herein are system, apparatus, article of manufacture, method and/or computer program product embodiments, and/or combinations and sub-combinations thereof, for dynamically determining when sensor data collected by an edge device should be processed locally (e.g., at an edge device) or offloaded to a remote cloud system for additional compliance analysis. In some examples, a computer-implemented method is disclosed for dynamically determining when sensor data collected by an edge device should be processed locally (e.g., at an edge device) or offloaded to a remote cloud system for additional compliance analysis. The computer-implemented method may include obtaining, by an edge device, sensor data associated with an environment; processing, by the edge device, the sensor data using a multimodal machine learning model configured to identify a compliance-related object within the environment and one or more visual indicators associated with the compliance-related object; detecting, by the edge device, a compliance violation associated with the identified compliance-related object based on the identified compliance-related object and the one or more visual indicators; determining, by the edge device, context information associated with the detected compliance violation; generating, by the edge device and based on the detected compliance violation, an evidence package comprising at least a portion of the sensor data associated with the detected compliance violation; and determining, by the edge device, one or more distributed processing operations for the evidence package based on the context information.

In some cases, a computing system is provided for dynamically determining when sensor data collected by an edge device should be processed locally (e.g., at an edge device) or offloaded to a remote cloud system for additional compliance analysis. The computing system may include at least one memory used to store data, such as computing instructions; and at least one processor coupled to the at least one memory and configured to perform operations including obtaining, by an edge device, sensor data associated with an environment; processing, by the edge device, the sensor data using a multimodal machine learning model configured to identify a compliance-related object within the environment and one or more visual indicators associated with the compliance-related object; detecting, by the edge device, a compliance violation associated with the identified compliance-related object based on the identified compliance-related object and the one or more visual indicators; determining, by the edge device, context information associated with the detected compliance violation; generating, by the edge device and based on the detected compliance violation, an evidence package comprising at least a portion of the sensor data associated with the detected compliance violation; and determining, by the edge device, one or more distributed processing operations for the evidence package based on the context information.

In some cases, a non-transitory computer-readable medium is provided for dynamically determining when sensor data collected by an edge device should be processed locally (e.g., at an edge device) or offloaded to a remote cloud system for additional compliance analysis. In some instances, the non-transitory computer-readable medium can have instructions stored thereon that, when executed by one or more processors, cause the one or more processors to perform operations including obtaining, by an edge device, sensor data associated with an environment; processing, by the edge device, the sensor data using a multimodal machine learning model configured to identify a compliance-related object within the environment and one or more visual indicators associated with the compliance-related object; detecting, by the edge device, a compliance violation associated with the identified compliance-related object based on the identified compliance-related object and the one or more visual indicators; determining, by the edge device, context information associated with the detected compliance violation; generating, by the edge device and based on the detected compliance violation, an evidence package comprising at least a portion of the sensor data associated with the detected compliance violation; and determining, by the edge device, one or more distributed processing operations for the evidence package based on the context information.

### BRIEF DESCRIPTION OF THE FIGURES

The accompanying drawings are incorporated herein and form a part of the specification.

FIG. 1 illustrates a block diagram of a compliance monitoring environment, according to some examples of the present disclosure;

FIG. 2 illustrates a block diagram of an edge device, according to some examples of the present disclosure;

FIG. 3A illustrates a block diagram of an example distributed processing architecture for a compliance monitoring environment, according to some embodiments of the present disclosure;

FIG. 3B illustrates a training framework for training, fine-tuning, or adapting an AI/ML model for operation within a defined domain, according to some examples of the present disclosure;

FIG. 3C illustrates an example compliance violation detection and analysis model, according to some examples of the present disclosure;

FIG. 4A illustrates a flow chart of an example process for implementing distributed processing operations for compliance monitoring, according to some examples of the present disclosure;

FIG. 4B illustrates a flow chart of an example process for optimizing inference execution and execution control within a distributed compliance monitoring architecture, according to some examples of the present disclosure;

FIG. 4C illustrates a flow chart of an example process for determining distributed processing configurations prior to performing substantive compliance violation detection or context analysis, according to some examples of the present disclosure;

FIG. 5 is a diagram illustrating an example of a neural network architecture, according to some examples of the present disclosure; and

FIG. 6 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Governing entities and other agencies are tasked with managing and maintaining various aspects of public and private infrastructure, including but not limited to public use areas, municipal assets and regulatory zones. Governing agencies may be subject to various internal and external government requirements or standards associated with the management and maintenance of their associated local jurisdictions, which may be based on or established through internal policies, regulatory frameworks, municipal codes, and/or state or national laws. The coordination of management and maintenance activities may be difficult due to various factors, including, but not limited to, the size of the geographic region, the number and complexity of maintenance requirements, and/or the extent to which such requirements are intermingled and interconnected. Examples of the internal or external government requirements include, but is not limited to, regulatory and infrastructure-related requirements and safety-related requirements.

As described herein, regulatory and infrastructure-related requirements may be associated with the maintenance, upkeep and functional integrity of public assets, transportation systems and general municipal infrastructure, as discussed in further detail below. Safety-related requirements may be associated with the prevention, mitigation, and resolution of hazards that may pose risks to public safety, vehicular traffic, and/or municipal infrastructure.

In some cases, the local governing entities may engage with contractors (e.g., street cleaners, landscapers, etc.) to assist in the management and maintenance of the associated local jurisdiction via service level agreements (SLAs). The SLAs may be based on the internal and/or external governmental requirements. Moreover, the SLAs may identify or indicate contractual obligations for the local governing entities and/or the contractors.

The management and maintenance of the local jurisdiction may become more difficult for the local governing entities when contractors are engaged by the local governing entities to assist in managing and maintaining the jurisdiction. For example, the governing entities may ensure that contractors comply with one or more service level agreements (SLAs) established between the governing entities and the contractors. Moreover, the governing entities may ensure that they themselves are adhering to both internal and external governmental requirements. However, given the scale of these governing entities, the number of contractors operating under different SLAs, the number of agencies of the governmental entities within a given jurisdiction, the volume of SLAs and their associated requirements, and the interwoven nature of governmental compliance obligations, effectively monitoring adherence remains a formidable task. Conventional approaches to compliance monitoring are often manual, resource-intensive, and inefficient in detecting violations in a timely manner, particularly when compliant monitoring includes a visual assessment.

The disclosed technology provides solutions for determining compliance of public infrastructure and other public and/or private use areas with one or more internal and/or external governmental requirements based on sensor data collected for the corresponding region(s). As discussed herein, sensor data can include data collected by one or sensor systems, including but not limited to image data, video data, Light Detection and Ranging (LiDAR) data, RADAR data, sonar data, and the like. In some examples, the disclosed technology provides solutions for determining whether contractor(s) operating under the agency or agencies are compliant with one or more requirements of one or more SLAs established between the governing entity and the contractor(s) based on video data and/or image data of one or more region(s) of the local jurisdiction. In some cases, the disclosed technology described herein may use computer-based object detection techniques, methods and/or systems, to make such determinations. Further, the disclosed technology may include a system, apparatus, device, method and/or computer program product embodiment, and/or combinations and sub-combinations thereof (“systems and techniques” hereinafter) to provide the solutions described herein.

Moreover, the disclosed technology addresses the technical challenge that compliance monitoring based on visual sensor data is resource-intensive, particularly when deployed across large geographic regions and diverse infrastructure types. Processing high-volume video and image data for compliance assessment, contextual interpretation, and evidence generation can exceed the computational, memory, power, and latency constraints of edge-deployed devices, while centralized processing alone can introduce bandwidth bottlenecks and delayed response times.

As described herein, the disclosed technology implements a distributed processing architecture in which compliance violation detection and context analysis are dynamically partitioned between edge devices and remote computing systems (e.g., cloud-based servers), based on processing thresholds and contextual factors, including, but not limited to, system state, policy-driven criteria, and operational context. In some aspects, edge devices perform selective local analysis to identify potentially relevant compliance conditions and determine whether further processing is warranted. Based on processing thresholds, contextual signals, and policy-driven criteria, computationally intensive analysis may be deferred, escalated, or offloaded to higher-capacity cloud systems. This architecture enables scalable, policy-aware compliance monitoring while reducing unnecessary data transmission, preserving real-time responsiveness, and efficiently allocating computational resources across the system.

In some configurations, the distributed processing architecture described herein may perform processing allocation determinations prior to executing substantive compliance violation detection or context analysis on captured video data and/or image data. As described herein, such determinations may be performed to assess how incoming sensor data should be processed, including whether the data should be processed locally at an edge device, partially processed at the edge, or transmitted to a remote computing system for additional analysis. These pre-analysis determinations may be based on characteristics of the sensor data itself, system-level processing thresholds, and contextual signals associated with data capture, without requiring full compliance violation detection or semantic context interpretation.

In some examples, the pre-analysis distributed processing determinations may consider factors including, but not limited to, data volume, resolution, frame rate, scene complexity, environmental conditions, available computational resources, latency constraints, and connectivity state. Additionally, location information, known or expected locations of compliance-related objects, and proximity to policy-identified regions of interest may be used to influence how sensor data is sampled, filtered, or prioritized prior to substantive analysis. In this manner, the systems and techniques described herein may proactively manage processing load and data flow before executing more computationally intensive compliance violation detection or context analysis processes.

Additionally, or alternatively, distributed processing determinations may be performed after substantive compliance violation detection and/or context analysis has been executed. In such cases, the determinations may be based on characteristics of a detected compliance condition, including severity information and/or priority information associated with the violation. As described herein, severity information may characterize the potential impact, risk level, or safety implications of a detected condition, while priority information may reflect enforcement urgency, regulatory sensitivity, or jurisdiction-specific compliance requirements. Based on such information, the system may determine whether additional analysis, escalation, reporting, or evidence generation should be performed locally or offloaded to a higher-capacity computing system.

In some examples, the systems and techniques described herein may obtain sensor data, such as videos and/or images from one or more optical sensors operated by an edge device. The sensor data may include, without limitation, video data, image data, and other visual sensor outputs captured as the edge device operates within a local jurisdiction or monitored environment. In some aspects, the systems and techniques described herein may implement one or more compliance violation detection processes on the sensor data to identify objects, environmental conditions, or other visual indicators associated with potential non-compliance. Such processes may include object detection, classification, or related visual analysis techniques configured to detect conditions indicative of a compliance violation relative to one or more internal policies, regulatory requirements, or SLAs. In some cases, the compliance violation detection processes may include use of one or more artificial intelligence (AI) or machine learning (ML) models or algorithms to analyze the sensor data and determine whether a detected condition corresponds to a compliance violation.

In some aspects, the systems and techniques described herein may implement one or more context analysis processes to determine context information associated with the detected compliance violation. As described herein, the context information may characterize attributes associated with the detected compliance violation, such as, but not limited to, a type of violation, severity, condition state, location information, surrounding environment, or other situational factors derived from the sensor data. In some instances, the context analysis processes may include generation of structured or language-based outputs that summarize a detected compliance violation and associated context information. Such outputs may support reporting, notification, prioritization, or resolution workflows by providing concise and interpretable descriptions of detected conditions. In some configurations, the context analysis processes may include use of one or more AI/ML models or algorithms to provide the context information.

In some instances, the systems and techniques described herein may generate one or more notifications associated with detected compliance violations. The notifications may include sensor data, context information, location information, and violation characterizations, and may be transmitted to one or more relevant agencies, service providers, or responsible entities.

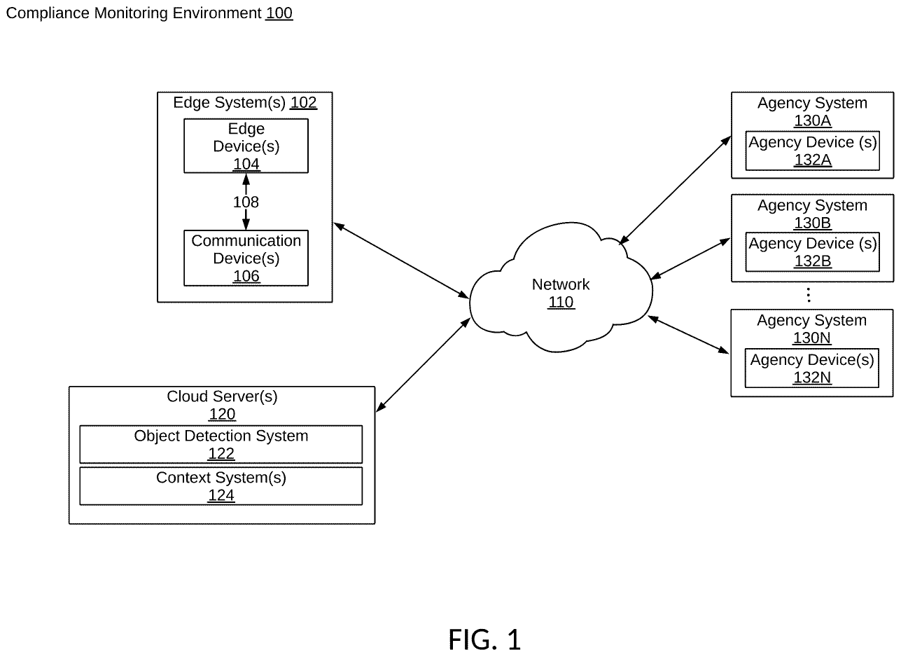

Various embodiments and aspects of this disclosure may be implemented using, and/or may be part of, compliance monitoring environment 100 shown in FIG. 1. It is noted, however, that the compliance monitoring environment 100 is provided for illustrative purposes and is not limiting. Examples and embodiments of this disclosure may be implemented using, and/or may be part of, environments that are different from and/or in addition to the compliance monitoring environment 100, as will be appreciated by persons skilled in the relevant art(s) based on the teachings contained herein. An example of the compliance monitoring environment 100 shall now be described.

### Example Compliance Monitoring Environment

FIG. 1 illustrates a block diagram of a compliance monitoring environment 100, according to some embodiments. In a non-limiting example, compliance monitoring environment 100 may be directed to detecting compliance violations relating to public infrastructure and/or other public and/or private use areas. However, this disclosure is applicable to any type of compliance monitoring (instead of or in addition to monitoring governmental agencies and contractors) and enforcement, as well as any mechanism, means, protocol, method, and/or process for obtaining, analyzing, and evaluating compliance-related data (e.g., video data, image data, object detection results, AI/ML-based assessments, etc.), identifying compliance violations, generating compliance-related notifications or reports, and determining resolution status of compliance violations within a monitored jurisdiction.

Compliance monitoring environment 100 may include edge system(s) 102, including one or more edge devices 104 that are configured to capture, process and analyze sensor data of regions of a local jurisdiction. Each edge device(s) 104 may be deployed in various environments, including, for example and without limitation, public roads, sidewalks, parks, transit stations, government buildings, waste management sites, pedestrian walkways, intersections, bridges, tunnels, public utility infrastructure, and/or other locations where compliance monitoring is required.

For example, a vehicle, such as a waste management vehicle, may include an edge device coupled to a windshield or bumper of the vehicle. The optical sensor(s) of the edge device may capture the videos and/or images as the vehicle travels around various regions of the local jurisdiction. The videos and/or images may include images of the regions of the local jurisdiction the vehicle was in.

In some examples, edge device(s) 104 may be configured to obtain video data and/or image data of one or more regions of a local jurisdiction, via one or more sensors, such as one or more optical sensors. In some aspects, edge device(s) 104 may serve as a first processing layer. Moreover, edge device(s) 104 may implement operations or processes related to compliance violation detection to process or analyze the video data and/or image data to determine or detect whether a compliance violation has occurred. For instance, edge device(s) 104 may use one or more AI/ML models (e.g., object detection models) to process or analyze the video data and/or image data to identify or detect one or more compliance-related objects or objects of interest, structures, environmental conditions and/or other visual indicators indicative of a compliance violation.

Examples of compliance-related objects or objects of interest, structures, environmental conditions and/or other visual indicators indicative of a compliance violation may include, but are not limited to, environmental elements (e.g., land cover element(s), topography elements(s), environmental conditions and objects, such as, but not limited to, trees, vegetation, and the like, etc.), large-scale infrastructure elements (e.g., roads, buildings, bridges, billboards, bus shelters, sidewalk, sidewalk curbs, a-frames, dining sheds, etc.), small-scale infrastructure elements (e.g., traffic-related elements (e.g., traffic signs, traffic signals, traffic cameras, road markers, line markings, parking meters, bicycle lane markers, public transit signs, road surface wear, etc.), utility-related elements (e.g., utility poles, streetlamps, post boxes, phone booths, etc.), emergency-related elements (e.g., emergency signals, fire hydrants, etc.), waste-related elements (e.g., receptacles, such as, but not limited to, trashcans/wastebin/waste container/garbage container, etc., waste identification (e.g., bulk waste, green waste, tire waste, construction waste, etc.), animal by-products (e.g., dead animal carcass, etc.), street furniture (e.g., benches, sculptures, fountains, etc.), debris type elements (e.g., road-surface debris) etc.), barrier-related elements (e.g., bollard), etc.), non-fixed form elements (e.g., graffiti), context sensitive elements (e.g., tire waste, visual pollution, waste around garbage/waste bins, illegal dumping, etc.), obstruction type conditions (e.g., signage obstructions, roadway or accessway obstructions), cleanliness type conditions (e.g., signage cleanliness), etc.), and/or dynamic composition elements (e.g., sand accumulation, drainage waste stemming from drainage issues).

In some instances, edge device(s) 104 may generate an evidence package. The evidence package may indicate the presence of a compliance violation, and/or portions of the video data or image data associated with the identified object(s), structure(s), environmental condition(s) and/or other visual indicator(s) indicative of the detected compliance violation. In some cases, edge device(s) 104 may include timestamps associated with the detected compliance violation.

Examples of AI/ML model(s) the systems and techniques described herein may use to make such identifications, detections and/or determinations, may include, but are not limited to, single-stage detector models (e.g., a YOLO (You Only Look Once) model, a SSD (single-shot detector) model, a RetinaNet model, an EfficientDet model, etc.), a two-stage detector model (e.g., a faster R-CNN model, a mask R-CNN model, etc.), a transformer-based model (e.g., a DETR (Detection Transformer), etc.), specialized object detection AI/ML models (e.g., a CenterNet model, a YOLOR (You Only Learn One Representation, etc.) Model, object tracking models with detection capabilities (e.g., a DeepSORT model, FairMOT model, etc.), and/or any other object detection AI/ML Model.

In some cases, edge device(s) 104 may implement context analysis processes to process or analyze the video data and/or image data to determine context information related to or associated with the detected compliance violation. Edge device(s) 104 may generate a coherent and contextually relevant language-based content associated with the compliance violation, based on the context information. The content may summarize and/or characterize the compliance violation. For example, edge device(s) 104 may use one or more additional AI/ML models (e.g., generative AI models) to process or analyze the evidence package (e.g., the portions of the video data or image data associated with the identified object(s), structure(s), environmental condition(s) and/or other visual indicator(s) indicative of the detected compliance violation and corresponding time stamps) to determine context information of a detected compliance violation. As described herein, context information may include, but is not limited to, the type of violation, characteristics of the violation (e.g., levels of damage, cleanliness, maintenance deficiencies), overall severity of the violation, and/or timestamp(s) associated with the compliance violation. Moreover, edge device(s) 104 may use the additional AI/ML model(s) to generate a coherent and contextually relevant language-based content based on the context information. In some instances, edge device(s) 104 may generate context data including the context information and/or the content based on the context information. In some aspects, the context data and/or the evidence package may be stored in a database associated with edge device(s) 104. Additionally, or alternatively, the context data and/or the evidence package may be stored locally in a memory device of edge device(s) 104 (e.g., storage/buffers 206). In some instances, the context analysis processes may be part of the first processing layer.

In some examples and as described herein, edge device(s) 104 may facilitate communication with cloud server(s) 120 to transmit the evidence package and/or context data, trigger notifications based on and/or including the content and/or the context information, and support further analysis related to compliance enforcement and resolution tracking of the compliance violation (e.g., change management of compliance violation).

Edge device(s) 104 may be configured to communicate with a network 110 via communication device(s) 106. The communication device(s) 106 may include, for example, a cable modem, a satellite television (TV) transceiver, a router, an access point, a network interface card, an antenna, etc. The edge device(s) 104 may communicate with the communication device(s) 114 over a link 116. The link 116 may include a wireless connection(s) (e.g., WIFI, etc.) and/or wired connection(s).

Network 110 can include one or more public and/or private networks. In some examples, the network 110 can include, without limitation, the Internet; a wide area network (WAN); a backbone network; a cloud network; a local area network (LAN); a datacenter network; a network segment; an Internet Service Provider (ISP) network; a wireless LAN; an intranet; an extranet; a wired and/or wireless network such as a cellular network, a Bluetooth network or link, an infrared network or link, a WIFI network, etc. ; and/or any other short range, long range, local, regional, global communications mechanism, means, approach, protocol and/or network, or any combination(s) thereof.

Compliance monitoring environment 100 may include one or more agency systems. In FIG. 1, compliance monitoring environment 100 includes agency systems 130A, 130B, and 130N (collectively “agency systems 130” hereinafter). However, the number of agency systems shown in FIG. 1 is merely one illustrative example provided for explanation purposes. In some examples, compliance monitoring environment 100 may include more agency systems than shown in FIG. 1. In some cases, compliance monitoring environment 100 may include less agency systems than shown in FIG. 1.

Agency system(s) 130 can each include one or more agency devices 132. Agency system(s) 130 may host, implement, and/or represent a government agency, department, regulatory body, or municipal office responsible for enforcing, managing and maintaining compliance with internal and external governmental requirements within the jurisdiction of a local governing entity. For example, agency device(s) 132 of agency system(s) 130 may manage, process, track, and enforce compliance-related activities (e.g., based on related internal or external government regulations), such as monitoring the condition of public infrastructure, ensuring adherence to safety regulations, overseeing service level agreements (SLAs) between contractors and governing entities, and managing compliance-related enforcement actions. The agency systems 130 may further store and manage compliance-related data. As described herein, compliance-related data may include, but is not limited to, data identifying and characterizing detected compliance violations, contextual information of each detected violations, maintenance tasks, maintenance schedules, performance metrics for each maintenance task, performance metrics for compliance violations (e.g., resolution timelines for compliance violations) and/or related internal or external governmental regulations (e.g., jurisdictional regulations, agency policies, etc.).

In some cases, agency system(s) 130 may communicate, coordinate, and exchange compliance-related data to other agency system(s) 130 to ensure comprehensive enforcement and resolution tracking across multiple government agencies. For example, different agency systems 130 may track and manage overlapping compliance responsibilities, such as monitoring road safety hazards, waste accumulation violations, and infrastructure maintenance requirements within a given local jurisdiction. Additionally, or alternatively, some agency systems 130 may maintain distinct compliance policies and enforcement standards while still sharing data with other agency systems for streamlined coordination and response management

Compliance monitoring environment 100 may also include one or more cloud servers 120. Cloud server(s) 120 may operate to support the edge device(s) 104, agency system(s) 130, and/or other compliance monitoring components from a remote location and/or network, such as a remote network, the cloud, a backend, a remote, or any distributed computing environment. It is noted that the structural and functional aspects of the cloud servers 120 may wholly or partially exist within in the same or different cloud servers. In some instances, cloud server(s) 120 may provide expanded computational capacity for performing more complex or higher-order compliance analysis relative to the edge device(s) 104.

For instance, edge device(s) 104 may obtain video data and/or image data of one or more regions of a local jurisdiction via one or more sensors, such as one or more optical sensors. Based on the video data and/or image data, the edge device(s) 104 may implement operations to process or analyze the video data and/or image data to determine or detect that a compliance violation has occurred with respect to a trash receptacle, such as determining that a trash bin is overflowing. Moreover, the edge device(s) 104 may further implement context analysis processes locally to process or analyze the video data and/or image data associated with the detected compliance violation to determine context information related to or associated with the compliance violation. The locally determined context information may be coarse in nature, such as identifying that the trash bin is overflowing without determining additional attributes of the violation. Further, the edge device(s) 104 may provide an evidence package, including one or more portions of the video data and/or image data associated with the detected compliance violation, and context data including the coarse context information, to cloud server(s) 120.

Cloud server(s) 120 may perform more fine-grained or higher-order context analysis on the video data and/or image data included in the evidence package using more computationally intensive AI/ML models. Moreover, cloud server(s) 120 may determine additional attributes of the compliance violation based on the more fine-grained or higher-order context analysis. For example, the cloud server(s) 120 may determine additional context information including, but not limited to, an estimated volume or percentage of overflow, a classification of waste type (e.g., household waste, bulk waste, construction debris), whether the overflow obstructs a pedestrian walkway or roadway, an estimated duration of the overflow condition based on historical data, a likelihood of secondary violations (e.g., attraction of pests or safety hazards), or a priority or severity level associated with the violation based on jurisdictional policies. In some instances, cloud server(s) 120 may generate or augment the evidence package to include such additional context information prior to transmission to one or more agency system(s) 130. Such an architecture may reduce computational load and conserve compute, memory, and power budgets at the edge device(s) 104 while preserving detection performance, particularly in circumstances where computational resources at the edge device(s) 104 are limited and to maintain fast and power-efficient inference operations.

In some examples, cloud server(s) 120 may include, host, operate, and/or implement one or more object detection system(s) 122 and one or more context system(s) 124. Object detection system(s) 122 may implement one or more compliance violation detection processes. The one or more compliance violation detection processes may include, but is not limited to, processing video data and/or image data acquired from one or more edge devices 104 to determine or detect an occurrence of a compliance violation. For example, object detection system 122 may use one or more AI/ML models (e.g., object detection model(s)) to identify one or more objects, structures, environmental conditions and/or other visual indicators within the video data and/or image data. Based on the detected objects, structures, environmental conditions and/or other visual indicators, object detection system 122 may determine an occurrence of a compliance violation. In some instances, cloud server(s) 120 may generate an evidence package. As described herein, the evidence package may include data indicating the presence of the compliance violation and/or portions of the video data and/or image data associated with the identified object(s), structure(s), environmental condition(s) and/or visual indicator(s) indicative of the detected compliance violation. In some instances, the evidence package may be stored in a database associated with cloud server(s) 120 to facilitate trend analysis, historical tracking, and proactive enforcement planning.

In configurations where edge device(s) 104 perform coarse context analysis and cloud server(s) 120 perform more fine-grained or higher-order context analysis of the same compliance violation, the AI/ML model(s) implemented by cloud server(s) 120 may differ in complexity, scale, or functionality from those implemented by the edge device(s) 104. For example, while edge device(s) 104 may implement lightweight or resource-efficient AI/ML models suitable for fast and power-efficient inference, cloud server(s) 120 may implement more computationally intensive AI/ML models, such as higher-order classifiers, vision-language models (VLMs), or combinations thereof, to perform deeper contextual interpretation of the video data and/or image data included in an evidence package. Moreover, the more computationally intensive AI/ML models may be configured to reason over richer visual features, historical data, policy information, or cross-modal representations to determine additional attributes of a detected compliance violation beyond those determined by the lightweight or resource-efficient AI/ML models.

In some instances, the AI/ML model(s) that identify object(s) or object(s) of interest (e.g., an object that the AI/ML model(s) are configured to detect and/or recognize within the sensor data, such as the video data and/or image data), environmental conditions and/or other indicators indicative of a compliance violation may be based on or trained on one or more training dataset(s). As described herein, the training dataset(s) may include high-resolution images of object of interests at varying scales, orientations, and environmental conditions. For example, the training dataset(s) may include multiple image sets, where each object of interest is depicted in different sizes, lighting conditions, backgrounds, and levels of occlusion. In configurations where different AI/ML models are implemented at the edge device(s) 104 and the cloud server(s) 120, the training dataset(s) used for such models may differ based on the intended level of analysis, available computational resources, and inference constraints. In some cases, object detection system(s) 122 may process the video data or image data captured by edge device(s) 104 to generate the training datasets. Examples of objects or objects of interest that the AI/ML model(s) may be configured to detect and/or recognize, include, but are not limited to, compliance-related objects or objects of interest, such as, small-scale infrastructure elements.

In some cases, cloud server(s) 120 may generate training datasets that include one or more synthetic images using one or more AI/ML model(s), such as generative AI model(s). The AI/ML model(s) may generate synthetic images of objects of interest based in part on sensor data, such as video data and/or image data of the objects of interest captured by edge device(s) 104. The AI/ML model(s) may create synthetic images depicting the small objects of interest under diverse environmental and visual conditions. In some examples, the synthetic images may depict the objects of interest at varying scales, orientations, occlusion levels, environmental contexts, and lighting conditions. The synthetic images may be blended with real-world environmental backgrounds to produce composite images that simulate real-world conditions within the monitored environment. Moreover, the synthetic images may provide additional context, views and perspectives that may not be determined from corresponding video data and/or image data captured by edge device(s) 104. AI/ML model(s) associated with identifying or recognizing object(s) or object(s) of interest, environmental conditions and/or other indicators indicative of a compliance violation may be based on or trained on the training dataset(s) with real-world video data and/or image data captured by edge device(s) 104 and/or training dataset(s) with the synthetic image(s). In some instances, the synthetic images may support cloud-based fine-grained or higher-order context analysis, where richer visual variability and contextual detail are beneficial.

Context system(s) 124 may implement processes related to context analysis of the determined compliance violation. The processes related to context analysis may include, but is not limited to, processing the video data and/or image data captured by the edge device(s) 104, such as the evidence package (e.g., portions of the video and/or image data corresponding to the detected objects, structures, environmental conditions, and/or other visual indicators that are indicative of the compliance violation), to determine or extract context information related to the compliance violation. In some instances, the one or more context analysis processes may include generating a coherent and contextually relevant language-based content based on the context information. As described herein, the content may summarize or characterize the compliance violation. For example, based on the evidence package, context system(s) 124 may use one or more AI/ML models (e.g., generative AI model(s)) to classify the type of violation, assess the severity of the violation, and determine characteristics of the violation, such as levels of damage, cleanliness, maintenance deficiencies, and associated timestamp(s)). Moreover, context system(s) 124 may use the AI/ML model(s) to generate a coherent and contextually relevant language-based content based on the context information. In some instances, context system(s) 124 may generate context data including the context information and/or the content based on the context information. In some instances, the context data may be stored in a database associated with cloud server(s) 120 to facilitate trend analysis, historical tracking, and proactive enforcement planning.

In some instances, the context information may include additional information, such as, but not limited to, time information, model confidence values. Additionally, or alternatively, the additional information may include location information associated with the detected compliance violation. As described herein, the location information may be based on location data generated by one or more location devices of sensor system 202. Moreover, edge device(s) 104 may corresponding location data generated by the location device(s) with video data and/or image data captured by optical sensor(s) of sensor system 202. In some cases, edge device(s) 104 and/or object detection system 122 may generate an evidence package that includes portions of the video data and/or image data associated with identified objects, structures, environmental conditions, and/or other visual indicators indicative of a detected compliance violation, together with corresponding location data. Further, context system(s) 124 may generate context information for the detected compliance violation that includes location information derived from the location data, such as geographic coordinates, geospatial metadata, network-based location estimations, street addresses, and/or other positioning information associated with the detected compliance violation.

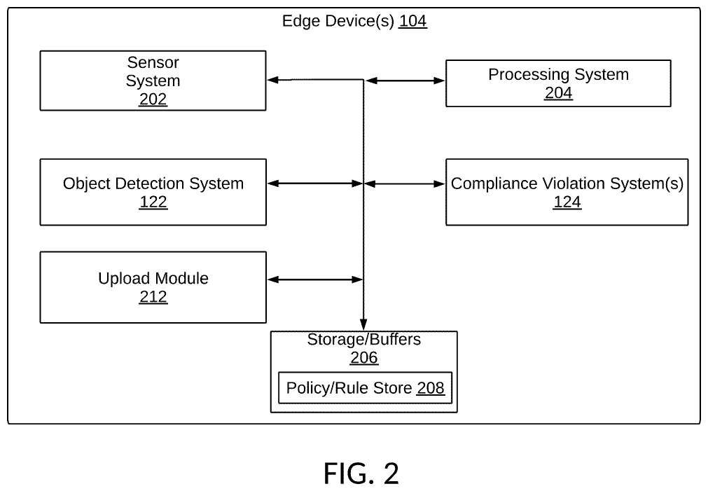

In some examples, edge device(s) 104 may include, implement and/or host a respective copy or version of object detection system(s) 122 and/or context system(s) 124 as shown in FIG. 2. Moreover, object detection system(s) 122 and/or context system(s) 124 may each include, implement, and/or host one or more servers, computers, models and/or neural networks (e.g., artificial intelligence (AI) and/or machine learning (ML) models and/or neural networks, statistical models, etc.), algorithms, software applications, software engines, software modules, software services, software code/logic, software components, processors and/or processing circuitry (e.g., central processing units (CPUs), digital signal processors (DSPs), graphics processing units (GPUs), image signal processors (ISPs), microprocessors, processor cores, system-on-chip (SOC) devices, application-specific integrated circuits (ASICs), field-programmable gate arrays (FPGAs), integrated circuits, etc.), software and/or hardware elements, software platforms, and/or any other hardware and/or software components.

In some configurations, the versions of object detection system(s) 122 and/or context system(s) 124 implemented at the edge device(s) 104 may be optimized for reduced computational complexity, memory footprint, and power consumption, while corresponding versions implemented at cloud server(s) 120 may be configured to support more computationally intensive or higher-order analysis. Such configurations enable a distributed compliance monitoring architecture that balances responsiveness and resource efficiency at the edge device(s) 104 with analytical depth and scalability at the cloud server(s) 120.

FIG. 2 illustrates a block diagram of an example of the edge device(s) 104, according to some embodiments of the present disclosure. In FIG. 2, the edge device(s) 104 represents a single edge device. Moreover, the edge device(s) 104 in FIG. 2 may include a data sensor system 202, a processing system 204, storage/buffers 206, and upload module 212. As described herein, sensor system 202 may include one or more sensors, such as optical sensors (e.g., Charge-Couple Device Sensors (CCD Sensors), Complementary Metal-Oxide Semiconductor (CMOS) sensors, Single Photon Avalanche Diode (SPAD) sensors, OMNIVISION image sensors, etc.).

In some examples, sensor system 202 may include, or may be communicatively coupled to, one or more location devices configured to generate location data associated with the edge device(s) 104 and/or sensor data captured by the edge device(s) 104. The location device(s) may be integrated within the edge device(s) 104 or implemented as separate components that communicate with the edge device(s) 104 via wired or wireless interfaces. The location data generated by the location device(s) may include location information associated with video data and/or image data captured by the optical sensors of the sensor system 202. Moreover, the location data may be used to associate captured sensor data with corresponding geographic positions within a monitored local jurisdiction. In some configurations, the location data may include precise location information, including location information with sub-meter or centimeter-level accuracy. In such configurations, the location device(s) may include a real-time kinematic (RTK)-enabled global navigation satellite system (GNSS) receiver or other high-precision positioning technology. Further, the location data may support or facilitate downstream processing performed by the edge device(s) 104 and/or cloud server(s) 120, including, but not limited to, context analysis processing, longitudinal tracking of compliance conditions over time, and spatial clustering of compliance events across locations and time periods within the monitored jurisdiction, as described in further detail herein.

In some instances, the downstream processes supported by location data, as described above, may include spatial mapping of compliance-related objects or objects of interest within a monitored local jurisdiction. In such instances, edge device(s) 104 and/or cloud server(s) 120 may be configured to generate and maintain spatial mappings of compliance-related objects or objects of interest within a monitored local jurisdiction. Location information associated with such compliance-related objects or objects of interest may be obtained from one or more sources, including, without limitation, location data embedded within video data and/or image data captured by sensor system 202 and/or location data obtained from third-party data sources, such as agency system(s) 130, asset registries, or mapping databases. For example, location information may be derived from metadata generated by one or more location devices associated with edge device(s) 104 and/or may correspond to reference or expected locations of infrastructure assets provided by an external system associated with a local jurisdiction.

The location information obtained from third-party data sources or agency system(s) 130 may be stored locally at edge device(s) 104 and updated periodically based on refreshed datasets, synchronization events, or policy updates. Such location information may be stored in one or more local storage structures, such as storage/buffers 206, including, for example, within or in association with policy/rule store 208 or another locally accessible data store. In this manner, edge device(s) 104 may maintain locally cached location information for compliance-related objects or objects of interest, enabling efficient access during detection, context analysis, or proximity-based processing without requiring continuous retrieval from remote systems.

In some examples, spatial mappings of compliance-related objects or objects of interest may be refined over time using iterative tracking across multiple detections. For example, an initial location estimate for a compliance-related object may be obtained from third-party data sources, such as agency system(s) 130, and/or derived from location data embedded within video data and/or image data captured by edge device(s) 104. Repeated detections of the same object across different edge device passes, viewing angles, or time periods may then be used to progressively refine the estimated position of the object, reconcile discrepancies between reference locations and sensor-derived locations, or improve overall spatial accuracy. In this manner, spatial mapping may serve as a supporting function that enhances downstream compliance monitoring workflows, including proximity-based capture strategies, longitudinal tracking, spatial clustering, and trend analysis, as described in further detail herein.

In some cases, location data and/or location information associated with a compliance-related object or object of interest may be obtained by an edge device 104 and an associated vehicle hosting the edge device 104. Moreover, the location data and/or location information may be used to influence or direct vehicle movement for targeted data acquisition. For example, based on location information indicating a known or suspected location of a compliance-related object (e.g., a traffic sign, hydrant, or accessibility feature), the vehicle may be routed, guided, or instructed to travel to, pass by, or reposition relative to the indicated location so that the edge device 104 may capture additional video data and/or image data of the compliance-related object. In some instances, such routing or repositioning may be performed automatically based on proximity thresholds, inspection schedules, or confidence levels associated with prior detections, while in other configurations such routing may be provided as navigational guidance or task instructions to a vehicle operator. In this manner, location information associated with compliance-related objects may be used not only for contextual analysis and spatial mapping, but also to actively coordinate vehicle-assisted inspection and targeted sensor data capture by the edge device(s) 104.

In some aspects, processing system 204 of the edge device(s) 104 may include one or more processors configured to execute one or more data handling, security, and device management functions in connection with sensor data captured by the sensor system 202. The processing system 204 may operate in coordination with object detection system(s) 122 and/or context system(s) 124, as described herein, and may include one or more functional modules configured to prepare, secure, manage, and update data and software components of the edge device(s) 104.

In some configurations, processing system 204 may include a compression and/or encryption module configured to process video data and/or image data captured by the sensor system 202. The compression portion of the module may compress video data and/or image data using one or more compression formats, such as, but not limited to, H.264, H.265, JPEG, WebP, or other suitable compression techniques. The encryption portion of the module may encrypt the video data and/or image data using one or more encryption schemes, such as symmetric or asymmetric encryption techniques, including, but not limited to, Advanced Encryption Standard (AES)-based schemes (e.g., AES-256), RSA-based schemes, or combinations thereof. The compression and/or encryption of video data and/or image data may be performed after processing by the object detection system(s) 122 and/or context system(s) 124.

For instance, after a compliance violation is detected and associated context information is determined, one or more portions of the video data and/or image data associated with the compliance violation may be selected for inclusion in an evidence package and subsequently compressed and/or encrypted prior to storage or transmission. In such an instance, cloud server(s) 120 and/or agency system(s) 130 receiving the evidence package may decrypt and/or decompress the video data and/or image data prior to further analysis or review.

In some aspects, processing system 204 may include an update module. The update module may be configured to manage updates to one or more software and/or firmware components of the edge device(s) 104. Moreover, the update module may receive update data from cloud server(s) 120, for example via wired or wireless communication interfaces. Further, the update module may apply the update data to various components of the edge device(s) 104. By way of example and without limitation, the update data may include updates to an operating system and low-level firmware or device drivers of the edge device(s) 104, software associated with the sensor system 202 including camera software and location device software (e.g., GNSS or RTK-related software), communication interfaces or communication devices (e.g., Wi-Fi, Bluetooth, or cellular interfaces), application software, computer vision or machine learning algorithms, controllers, compression and encryption methods, and configuration or policy files such as rules defining compliance requirements, evidence formats, or prioritization criteria.

In some examples, edge device(s) 104 may optionally include a copy or version of object detection system(s) 122. Moreover, edge device(s) 104 may optionally include a copy or version of context system(s) 124. In some instances, edge device(s) 104 may include a copy, version of object detection system(s) 122 and/or the context system(s) 124, enabling the edge device(s) 104 to perform some or all of the operations, tasks, functions, and/or actions of the object detection system(s) 122 and/or context system(s) 124.

For example, the edge device(s) 104 may optionally include a copy or version of object detection system(s) 122 and/or context system(s) 124 to allow the edge device(s) 104 to perform any of the tasks, operations, functions, etc., described herein with respect to object detection system(s) 122 and/or context system(s) 124 (e.g., in addition to or instead of any of such tasks, operations, functions, etc. (or portions thereof), performed by the object detection system(s) 122 and/or context system(s) 124 at/from cloud server(s) 120 shown in FIG. 1).

In some cases, object detection system(s) 122 may be a localized version, a client-side version, a standalone version, and/or a lightweight version of object detection system(s) 122 implemented at the cloud server(s) 120. For instance, the localized version may be designed to operate with reduced data size, fewer components, features, functions, modules, libraries, or capabilities, or a smaller code package relative to object detection system(s) 122 hosted at the cloud server(s) 120.

In some aspects, context system(s) 124 may be a localized version, a client-side version, a standalone version, and/or a lightweight version of context system(s) 124 implemented at the cloud server(s) 120. For instance, the localized version may be designed to operate with reduced data size, fewer components, features, functions, modules, libraries, or capabilities, or a smaller code package relative to context system(s) 124 hosted at the cloud server(s) 120.

In some instances, edge device(s) 104 may further include storage/buffers 206 configured to store data generated, received, or processed by the sensor system 202 and the processing system 204. Storage/buffers 206 may include volatile and/or non-volatile memory and may be used to temporarily or persistently store sensor data, metadata, intermediate processing results, and evidence packages, as described herein. In some aspects, storage/buffers 206 may support continued operation of the edge device(s) 104 under varying network, bandwidth, or power conditions.

In some examples, storage/buffers 206 may include a policy/rule store 208. The policy/rule store 208 may store rule information and/or policy information that defines, characterizes, or constrains compliance monitoring operations performed by the edge device(s) 104. In some examples, the rule information may define or characterize jurisdiction-specific requirements, including internal or external governmental requirements, service-level agreements (SLAs), maintenance responsibilities, or compliance policies applicable within a monitored local jurisdiction.

In some cases, policy/rule store 208 may store rule information. The rule information may define or characterize, without limitation, what conditions constitute a compliance violation, when maintenance or remediation is required and associated urgency levels, and detection sensitivity thresholds used by object detection system(s) 122 and/or context system(s) 124 when determining whether a compliance violation has occurred. The detection sensitivity thresholds may specify allowable condition ranges, tolerance levels, or escalation criteria, and may vary based on asset type, jurisdictional policy, or operational context.

Additionally, or alternatively, policy/rule store 208 may store policy information. Policy information may include asset-related data defining or characterizing compliance objects or objects of interest. Examples of asset-related data may include, and without limitation, identifiers or classifications of compliance objects or objects of interest, location or positioning information associated with such objects, and priority or criticality indicators identifying assets that are safety-critical or otherwise require heightened monitoring or expedited response. In some cases, the asset-related data, such as the location or positioning information associated with the compliance objects or objects of interest, may be initially coarse and refined over time, as described in further detail herein.

In some aspects, information stored in the policy/rule store 208 may be accessed by object detection system(s) 122 and/or context system(s) 124 during processing of video data and/or image data. For example, rule and policy information may influence determinations of whether a detected condition constitutes a compliance violation, the severity or priority associated with the violation, or the level of analysis applied to detected objects or conditions. Such use of the policy/rule store 208 enables compliance monitoring operations to be tailored to jurisdiction-specific requirements and asset-specific characteristics.

In some instances, the policy/rule store 208 may store privacy-related policy/rule information. The privacy-related policy/rule information may specify handling requirements for sensitive data detected within video data or image data, including faces, license plates, or other personally identifiable or regulated information. In some instances, based on the privacy-related policy/rule information, the edge device(s) 104 may anonymize, obfuscate, redact, or otherwise process portions of the video data or image data prior to storage, transmission, or inclusion in an evidence package.

For instance, the policy/rule store 208 may include privacy-related policy or rule information indicating that faces of individuals captured in video data or image data are to be anonymized. Moreover, edge device(s) 104 may obtain video data and/or image data associated with a compliance-related object or an object of interest, such as a trash bin. The video data or image data may also include depictions of people in proximity to the compliance-related object, including their faces. Furthermore, edge device(s) 104 may identify and detect not only the compliance-related object or object of interest, but also the people and corresponding facial features appearing in the video data or image data. Based on the privacy-related policy or rule information stored in the policy/rule store 208, the edge device(s) 104 may implement one or more privacy-related processing operations on the video data and/or image data, such as obfuscating, anonymizing, or otherwise modifying the facial features of the people depicted therein. In some instances, such privacy-related processing may be performed prior to processing by context system(s) 124, whether such context analysis is performed locally at the edge device(s) 104 or remotely by cloud server(s) 120, such that the unmodified video data or image data including the facial features of the people does not leave the edge device(s) 104.

In some examples, device(s) 104 may use the rule information and/or policy information when processing the video data and/or image data, such as for the selection, prioritization, and handling of evidence packages and associated context data. For example, based on the rule information and/or policy information, edge device(s) 104 may determine which portions of captured sensor data are relevant for further analysis, which detected conditions warrant generation of an evidence package, and how detected compliance violations are characterized in terms of priority or severity. For instance, based on rule information defining urgency thresholds, asset criticality, or allowable condition ranges, the edge device(s) 104 may determine whether a detected condition constitutes a minor issue or a higher-impact compliance violation requiring expedited handling. In some instances, edge device(s) 104 may use the priority or severity determinations to decide whether associated evidence packages and context data are processed locally, transmitted immediately to cloud server(s) 120, deferred for later transmission, or retained locally until sufficient computing, bandwidth, or network resources are available. In this manner, the policy/rule store 208 enables the edge device(s) 104 to perform policy-aware, resource-efficient compliance monitoring while coordinating with cloud-based processing and reporting workflows.

In some cases, storage/buffers 206 may include local storage. The local storage may provide a local persistent storage layer for archiving raw video data, image data, cropped regions of interest, metadata, and evidence packages. Moreover, the local storage may ensure that sensor data and compliance-related data (e.g., the evidence package, video/image data of compliance violations, and/or associated context data) are not lost during periods of limited or unavailable network connectivity. In some examples, retention duration for locally stored data may be determined based on rule information and/or policy information stored in the policy/rule store 208, including urgency levels, asset criticality, severity thresholds, available system resources, or operational status of the edge device(s) 104.

For example, rule information and/or policy information stored in the policy/rule store 208 may define one or more severity or priority levels associated with different types of compliance violations, and corresponding baseline retention periods for locally stored data. In some cases, a compliance violation classified as high severity or high priority, such as a safety-critical condition involving infrastructure damage or obstruction (e.g., a fallen streetlight pole), may be associated with a longer local retention period, for example retaining related video data, image data, and evidence packages for sixty (60) days to support investigation, enforcement, or follow-up maintenance activities. In contrast, a compliance violation classified as lower severity or lower priority, such as a minor or cosmetic issue (e.g., minor graffiti), may be associated with a shorter local retention period, for example retaining related data for ten (10) days, after which the data may be deleted or overwritten if no longer needed.

In some aspects, edge device(s) 104 may apply or adapt the policy-defined retention periods based on current system conditions or operational context. For example, retention decisions may consider available storage capacity, bandwidth availability, network connectivity, or operational state of the edge device(s) 104, such as whether a service vehicle is stationary, actively operating, or transitioning between locations. In this manner, while baseline retention durations may be defined by severity or priority levels in the policy/rule store 208, the edge device(s) 104 may dynamically manage local storage to balance resource constraints with the need to preserve data associated with high-impact or time-sensitive compliance events.

As described herein, upload module 212 may be configured to manage reporting, offloading, and transmission of data from the edge device(s) 104 to one or more cloud server(s) 120 and/or agency system(s) 130. The upload module 212 may operate in coordination with object detection system(s) 122 and/or context system(s) 124 and may use information stored in the policy/rule store 208 to control how and when evidence packages, video data, image data, and associated context data are transmitted. In this manner, the upload module 212 supports distributed processing and/or reporting of detected compliance violations while enabling scalable, low-latency, and resource-efficient compliance monitoring operations.

In some configurations, upload module 212 may include a severity engine. The severity engine may be configured to determine a severity level or priority level associated with a detected compliance violation. The severity engine may determine the severity or priority level based on a compliance-related object detected by object detection system 122, context information generated by context system(s) 124 and/or rule information and/or policy information stored in the policy/rule store 208. By way of example, context information used by the severity engine may include characteristics of a detected compliance object or object of interest (e.g., type or importance), location or positioning of the compliance violation, and visual status classifications associated with the detected condition (e.g., intact versus damaged, clean versus overflowing, visible versus obstructed), which may be coarse or fine-grained in nature. Moreover, the rule information and/or policy information used by the severity engine may include jurisdiction-specific rules defining compliance priorities, reporting thresholds, or enforcement preferences. For instance, the rule information may specify which types of compliance violations and/or compliance-related objects are considered safety-critical, which violations warrant immediate reporting, and which conditions may be tolerated within defined limits. Based on the rule information and/or policy information, the severity engine may determine how detected compliance violations are categorized and may associate corresponding severity or priority information with an evidence package and/or associated context data for use in downstream processing and reporting.

In some examples, the severity or priority information may correspond to one or more discrete severity levels. For example, a first severity level may correspond to a high-priority or safety-critical compliance violation, such as damage to traffic control infrastructure, obstruction of a pedestrian walkway or roadway, or failure of a safety-related asset. Additionally, or alternatively, the first severity level may indicate that immediate reporting and remediation are required. Moreover, a second severity level may correspond to a medium-priority compliance violation, such as a condition that degrades asset performance or usability but does not pose an immediate safety risk. Additionally, or alternatively, the second severity level may indicate that reporting or remediation should occur within a defined time window. Further, a third severity level may correspond to a low-priority compliance violation, such as a minor cosmetic issue or a condition within an allowable tolerance range. Additionally, or alternatively, the third severity level may indicate that the violation is suitable for deferred reporting, trend analysis, or monitoring over time. In some instances, the severity level may correspond to a minor, unclear, or below-threshold compliance condition. Additionally, or alternatively, such a severity level may indicate that a corresponding candidate evidence package may be stored locally for later transmission, trend analysis, or deferred reporting when network or system resources permit.

In some aspects, upload module 212 may further include an upload controller. The upload controller may be configured to implement reporting and offloading operations based on the severity or priority information generated by the severity engine. For example, and following the examples above, for evidence packages with the first severity level corresponding to a high-priority or safety-critical condition, the upload controller may cause the associated evidence package to be generated and transmitted with elevated priority (e.g., immediately or ahead of other pending data transmissions). Moreover, for evidence packages with the second severity level corresponding to a medium-priority condition, the upload controller may transmit the associated evidence package within a defined time window or based on available network or system resources. Further, for evidence packages with the third severity level corresponding to a low-priority condition, the upload controller may defer transmission of the associated evidence package, store the evidence package locally for trend analysis or monitoring, or transmit the evidence package during periods of lower network utilization or favorable operating conditions. In instances where the severity level corresponds to a minor, unclear, or below-threshold compliance condition, the upload controller may locally store (e.g., via local storage) a corresponding candidate evidence package for later transmission, trend analysis, or deferred reporting when network or system resources permit.

Additionally, or alternatively, the upload controller may consider state information associated with the edge device(s) 104 (e.g., connectivity type or quality, available bandwidth, power or battery state, and/or system health), and/or vehicle information of a vehicle hosting or associated with the edge device(s) 104 (e.g., vehicle operating state) when implementing reporting and offloading operations. For example, when a vehicle is actively operating or in motion, the upload controller may prioritize transmission of higher-priority evidence packages while deferring transmission of bulk data or lower-priority evidence packages. In contrast, when the vehicle is stationary, parked, or located at a depot, garage, or service facility and connected to a high-capacity network (e.g., wired network or high-bandwidth wireless network), the upload controller may transmit larger video files, lower-priority evidence packages, candidate evidence packages, or accumulated buffered data in batch. In another example, higher-priority evidence packages may be transmitted immediately over high-bandwidth connections, while bulk data, lower-priority evidence packages, or larger video files may be deferred until favorable network or system conditions are detected. In some instances, the upload controller may further support resumption of partially completed transmissions to avoid data loss.

### Distributed Processing of Video Data and/or Image Data of a Compliance Violation

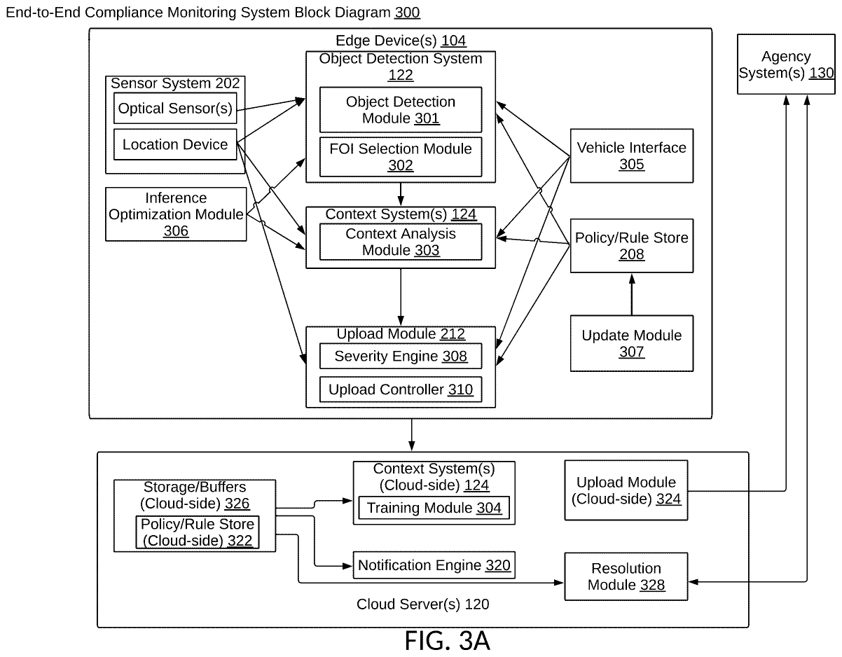

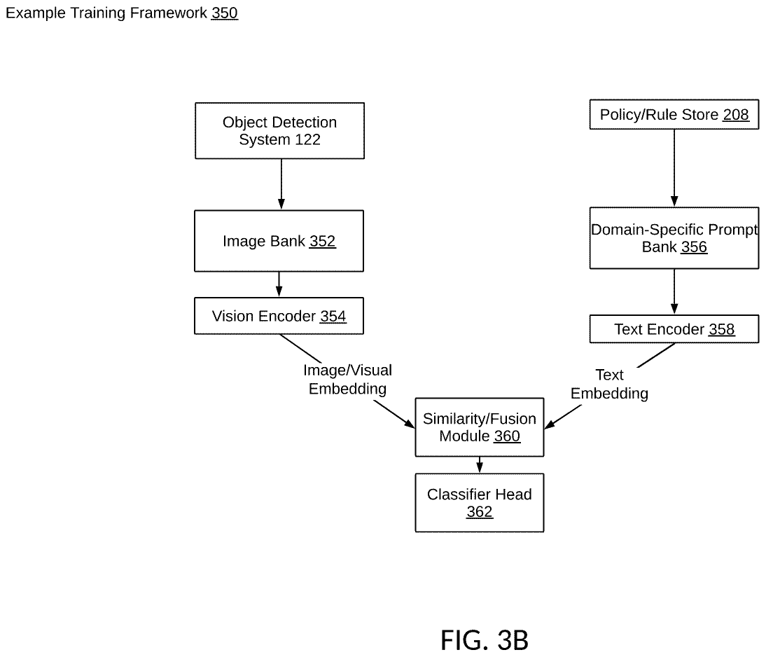

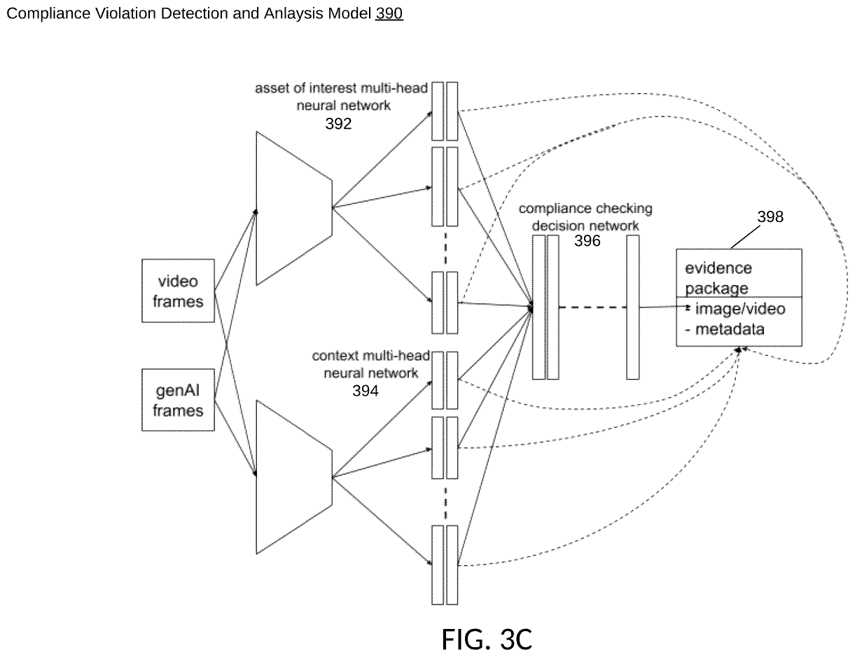

FIG. 3A illustrates a block diagram 300 of an example distributed processing architecture for compliance monitoring, according to some embodiments of the present disclosure. As described herein, the processing of video data and/or image data captured by edge device(s) 104, for compliance violation detection, context information of a detected compliance violation, and/or content generation summarizing or characterizing the detected compliance violation, may be distributed across edge device(s) 104 and cloud server(s) 120. As illustrated in FIG. 3A, object detection system 122 of edge device(s) 104 may include an object detection module 301, and context system(s) 124 of edge device(s) 104 may include a context analysis module 303. Object detection module 301 and context analysis module 303 may be configured to perform compliance violation detection processes and context analysis processes, respectively, in support of distributed compliance monitoring operations described herein.

As described herein, object detection module 301 may support compliance violation detection functionality corresponding to object detection system(s) 122. For example, object detection module 301 may be configured to implement one or more operations or processes related to compliance violation detection. Such processes may include, without limitation, analyzing video data and/or image data captured by sensor system 202 to determine or detect whether a compliance violation has occurred. In some instances, object detection module 301 may use one or more AI/ML models, such as object detection models, to process or analyze video frames or images to identify or detect one or more objects, structures, environmental conditions, and/or other visual indicators indicative of a compliance violation.

Moreover, object detection module 301 may generate, or cause generation of, an evidence package indicating the presence of a detected compliance violation. The evidence package may include, without limitation, portions of the video data and/or image data associated with the identified object(s), structure(s), environmental condition(s), and/or other visual indicator(s) indicative of the detected compliance violation. In some instances, the evidence package may further include associated metadata, such as timestamps, location data, detection confidence values, object identifiers, or combinations thereof. Although object detection module 301 is illustrated as being included in edge device(s) 104 in FIG. 3A, it should be appreciated that object detection module 301, or a functionally equivalent instance thereof, may additionally or alternatively be included in object detection system 122 implemented by cloud server(s) 120, depending on the distribution of processing within the compliance monitoring architecture.

Furthermore, context analysis module 303 may support context analysis functionality corresponding to context system(s) 124. For example, context analysis module 303 may be configured to implement one or more context analysis processes related to a detected compliance violation, such as, but not limited to, processing one or more portions of an evidence package (e.g., the video data and/or image data associated with identified object(s), structure(s), environmental condition(s), and/or other visual indicator(s) indicative of a compliance violation, together with corresponding timestamps and/or location data) to determine context information. Based on the context information, context analysis module 303 may generate coherent and contextually relevant language-based content associated with the detected compliance violation. The generated content may summarize and/or characterize the compliance violation based on the determined context information, such as a type of violation, characteristics of the violation (e.g., levels of damage, cleanliness, maintenance deficiencies), severity-related attributes, location information, and/or temporal attributes. Additionally, or alternatively, the determined context information may be used to assess a condition associated with a compliance-related object, and such assessed condition may be used in determining whether a compliance violation has occurred.

In some instances, context analysis module 303 may generate context data including the context information and/or the generated content and may associate such context data with the evidence package for use in downstream processing, prioritization, reporting, and notification workflows. In some configurations, context analysis module 303 may use one or more additional AI/ML models to process portion(s) of an evidence package to determine associated context information and/or to generate content based on the context information. Although context analysis module 303 is illustrated as being included in edge device(s) 104 in FIG. 3A, it should be appreciated that context analysis module 303, or a functionally equivalent instance thereof, may additionally or alternatively be included in context system(s) 124 implemented by cloud server(s) 120, depending on the distribution of processing within the compliance monitoring architecture.

The configurations for the distributed processing of the video data and/or image data may be based on computational capabilities and/or resources of the edge device(s) 104 and/or cloud server(s) 120, as well as network conditions, latency constraints, and/or the specific compliance monitoring requirements of a given jurisdiction. Examples of compliance violations includes, but is not limited to, violations related to the appearance of infrastructure element(s) of a local jurisdiction (e.g., orientation of a traffic sign, such as, a traffic sign that is tilted due to damage or heavy rain/wind or has fallen down), violations related to the access of the infrastructure element(s) (e.g., a blocked or obstructed fire hydrant or access point to a building, trees blocking traffic light or traffic sign, etc.), violations related to the appearance of the infrastructure elements (e.g., graffiti on traffic sign or bus stop structure), violations related to the function and operation of the infrastructure elements (e.g., streetlamps or traffic lights not functional), violations related to environmental conditions (e.g., tree growing exceed city limit, such as being higher than a height requirement or being too close to a building), violations related to waste management (e.g., overflow from street trash receptacle), and violations related to accessibility regulations (e.g., damage on a detectable warning plate or tactile warning surface for vision impaired person(s)). The architecture of FIG. 3A is provided by way of example only. Although FIG. 3A illustrates a single edge device 104 in communication with a single cloud server 120, the distributed processing architecture may include, without limitation, multiple edge devices 104 communicating with multiple cloud servers 120, a single edge device 104 communicating with multiple cloud servers 120 and/or multiple edge devices 104 communicating with a single cloud server 129. Any such variations, and combinations thereof, are contemplated as being within the scope of the present disclosure.

In some configurations, the distributed processing of the video data and/or image data may be based on specific compliance monitoring requirements of a given jurisdiction. In some examples, the specific compliance monitoring requirements of a given jurisdiction may be reflected in severity information and/or priority information associated with detected compliance violations. As described herein, the severity information and/or priority information may indicate how video data and/or image data associated with a detected compliance violation is to be processed, analyzed, stored, or transmitted within the distributed processing architecture. For example, severity and/or priority information may indicate whether processing is performed locally at the edge device(s) 104, offloaded to cloud server(s) 120, or shared between the edge device(s) 104 and cloud server(s) 120.

In some examples, the severity information and/or priority information associated with a detected compliance violation may define one or more selection, prioritization, and transmission operations within the distributed processing architecture. Moreover, the selection, prioritization, and transmission operation(s) may specify, for example, whether video data and/or image data associated with the detected compliance violation is to be processed entirely at the edge device(s) 104, partially processed at the edge device(s) 104 and partially processed at the cloud server(s) 120, or predominantly processed by the cloud server(s) 120. Additionally, or alternatively, the severity information and/or priority information may define timing requirements for processing, reporting, or transmission of the video data, image data, evidence package, and/or associated context data to cloud server(s) 120 and/or agency system(s) 130.

As described herein, the severity information and/or priority information may be based on rule information and/or policy information applicable to a monitored local jurisdiction. In some examples, such rule information and/or policy information may be stored in a policy/rule store (e.g., policy/rule store 208) and may define jurisdiction-specific compliance requirements, asset criticality classifications, urgency thresholds, or reporting preferences associated with different types of compliance-related objects or conditions.

For example, edge device(s) 104 may obtain video data and/or image data of one or more regions of a local jurisdiction via one or more optical sensors of sensor system 202. Object detection module 301 may process video frames of the video data and/or images of the image data to identify or detect one or more compliance-related objects, structures, environmental conditions, and/or other visual indicators. For instance, object detection module 301 may detect a compliance-related object such as a stop sign and further detect visual indicators suggesting a compliance violation, such as the stop sign being tilted, damaged, or fallen over. Moreover, object detection module 301 may generate an evidence package that includes one or more portions of the video data and/or image data associated with the detected compliance violation, such as video frames or image crops depicting the fallen stop sign. In some instances, and as described herein, the evidence package may further include metadata such as timestamps, location information, detection confidence values, or identifiers associated with the detected compliance-related object.

Context analysis module 303 of context system(s) 124 may process the evidence package to determine context information related to or associated with the detected compliance violation. Moreover, context analysis module 303 may generate context data based on the context information. As described herein, the context data may characterize the context information. For instance, context analysis module 303 may process the evidence package (e.g., one or more portions of video data and/or image data associated with the detected compliance violation) to determine that the stop sign has fallen over, identify the type of violation, assess characteristics of the violation (e.g., obstruction of traffic control, loss of visibility, or safety impact), and generate corresponding context data describing such determinations. In some instances, context analysis module 303 may generate language-based content summarizing or characterizing the detected compliance violation.

Upload module 212 may process the evidence package and/or the associated context data to obtain relevant rule information and/or policy information. For example, a severity engine of upload module 212, such as severity engine 308 of FIG. 3A, may identify rule information or policy information associated with the detected compliance-related object (e.g., a stop sign), such as whether the object is classified as safety-critical, applicable response time requirements, or reporting obligations defined by a local jurisdiction. Moreover, the severity engine may correlate the evidence package and context data with such rule information or policy information to evaluate the significance of the detected compliance violation. Based on the rule information and/or policy information and the evidence package and/or associated context data, the severity engine may determine severity information and/or priority information associated with the detected compliance violation. In some configurations, the severity engine may associate with the evidence package and/or associated context data the determined severity information and/or priority information. Additionally, or alternatively, the severity engine may augment the evidence package and/or associated context data to include the determined severity information and/or priority information.

In some instances, the severity information and/or priority information associated with a detected compliance violation may be determined based at least in part on location information associated with the detected compliance violation. As described herein, the location information may be included as part of the context information determined by context system(s) 124 (e.g., context analysis module 303) and may be derived from location data included in an evidence package. In such instances, the severity engine (e.g., severity engine 308) may use the location information when determining severity information and/or priority information for the detected compliance violation. For instance, the severity engine may identify or select relevant rule information and/or policy information applicable to the detected compliance violation based on the location information of the detected compliance violation. Moreover, the severity engine may determine severity information and/or priority information for the detected compliance violation based on the identified or selected relevant rule information and/or policy information, the corresponding evidence package and/or context data.

For example, an evidence package and/or context data may include location data and/or location information, respectively, indicating that a detected compliance violation involving a fallen stop sign occurred at a designated school zone intersection. Based on the location information determined from the location data, context system(s) 124 (e.g., context analysis module 303) and/or upload module 212 may identify rule information specifying that traffic control infrastructure violations occurring within school zones are classified as safety critical. Based on the rule information, the evidence package and/or associated context data, the severity engine may determine the severity information and/or priority information associated with the detected compliance violation is elevated relative to a similar violation occurring outside of the school zone. In some instances, the elevated severity or priority may be used to control subsequent selection, prioritization, processing, and transmission operations within the distributed processing architecture, as described herein.

In some configurations, the severity information and/or priority information associated with a detected compliance violation may be determined based at least in part on vehicle information of a vehicle associated with the edge device(s) 104. As described herein, the vehicle information may be obtained from a vehicle interface communicatively coupled to the edge device(s) 104, such as vehicle interface 305 of FIG. 3A. In some examples, the vehicle interface may include a vehicle communication interface configured to access vehicle telemetry or operational data, such as a controller area network (CAN) bus, an on-board diagnostics (OBD) interface, or another vehicle data interface. Examples of vehicle information include, but are not limited to, vehicle operating state information such as whether the vehicle is stationary or in motion, vehicle speed, acceleration or deceleration status, gear state, ignition state, braking activity, steering activity, vehicle heading, route or path information, or combinations thereof. Additionally, or alternatively, the vehicle information may include vehicle mission or operational context information, such as whether the vehicle is performing a scheduled inspection route, returning to a depot, idling at a location, or operating under normal transit conditions.

In some examples, the severity engine (e.g., severity engine 308) may use the vehicle information, alone or in combination with evidence package data, context data, location information, and rule information and/or policy information, to determine severity information and/or priority information for a detected compliance violation. For example, a compliance violation detected while the vehicle is stationary, operating at low speed, or performing a designated inspection operation may be assigned elevated severity or priority due to increased detection confidence or inspection reliability. In contrast, a similar compliance violation detected while the vehicle is traveling at higher speed or under transient operating conditions may be assigned a lower severity or priority or may be flagged for confirmation by additional inspection passes or other vehicles.

Additionally, or alternatively, vehicle information may be used to escalate severity information and/or priority information based on persistence or corroboration. For example, if multiple vehicles associated with different edge device(s) 104 detect the same compliance violation at a similar location over time, or if a compliance violation persists across multiple vehicle passes, the severity engine may increase the severity or priority associated with the detected compliance violation. In this manner, vehicle information enables severity and priority determinations that account for inspection context, confidence, and persistence, thereby improving the accuracy and effectiveness of downstream selection, prioritization, and transmission operations within the distributed processing architecture.

As described herein, severity information may characterize the seriousness, impact, or potential risk associated with the detected compliance violation, while priority information may characterize the relative urgency, handling order, or reporting precedence of the detected compliance violation relative to other detected compliance violations. In some instances, severity information and priority information may be the same or overlapping, while in other instances they may represent distinct but related characterizations used for different downstream purposes.

In some examples, the severity information and/or priority information determined by upload module 212 may correspond to one or more discrete severity levels or priority levels. Each severity level or priority level may represent a predefined category of compliance impact and may be associated with corresponding selection, prioritization, and transmission operation(s). As described herein, the selection, prioritization, and transmission operation(s) may define how the video data, image data, evidence package, and/or associated context data are selected, prioritized, processed, stored, or transmitted by the edge device(s) 104 and/or cloud server(s) 120.

For example, a first severity level may correspond to a high-severity or high-priority compliance violation, such as a safety-critical condition involving traffic control infrastructure, public safety assets, or accessibility-related elements. In such example, the severity information or priority information may indicate that the associated evidence package and context data are to be selected for expedited handling, including immediate or near-immediate transmission from the edge device(s) 104 to cloud server(s) 120 and/or agency system(s) 130, and may further indicate that more detailed or higher-fidelity processing is to be applied.

In contrast, a second or lower severity level may correspond to a medium-or low-priority compliance violation, such as a condition that degrades asset appearance or performance without posing an immediate safety risk. The severity information and/or priority information associated with a second or lower severity level may indicate that the associated evidence package and context data may be deprioritized, stored locally at the edge device(s) 104, aggregated with other detected events, or transmitted to cloud server(s) 120 based on available network resources, latency constraints, or scheduling policies.

In some configurations, upload module 212 may implement selection, prioritization, and transmission operation(s) for an evidence package and/or associated context data based on corresponding severity information and/or priority information. For example, an upload controller of upload module 212, such as upload controller 310 of FIG. 3A, may be configured to implement the selection, prioritization, and transmission operation(s) for video data, image data, evidence packages, and associated context data based on severity information and/or priority information determined by the severity engine, as described herein.

In some examples, the upload controller (e.g., upload controller 310) may map severity information and/or priority information to one or more predefined handling policies that specify selection, prioritization, batching, deferral, or immediate transmission behaviors. For example, for evidence packages associated with a first severity level corresponding to a high-priority or safety-critical compliance violation (e.g., compliance violations involving traffic control infrastructure, public safety assets, or accessibility-related elements), the upload controller may cause the corresponding evidence package and associated context data to be generated with elevated priority and transmitted immediately or ahead of other pending data transmissions.

In another example, for evidence packages associated with a second severity level corresponding to a medium-priority compliance violation, the upload controller (e.g., upload controller 310) may transmit the corresponding evidence package within a defined time window, in accordance with available network resources, system conditions, or scheduling policies.

In another example, for evidence packages associated with a third severity level corresponding to a low-priority or below-threshold compliance violation, the upload controller may defer transmission, store the evidence package locally at the edge device(s) 104 (e.g., local storage of storage/buffers 206), aggregate the evidence package with other detected events, or schedule transmission during periods of lower network utilization or otherwise favorable operating conditions. In some instances, such deferred evidence packages may be designated as candidate evidence packages for trend analysis, monitoring, or later escalation.

In some cases, the upload controller (e.g., upload controller 310) may consider state information associated with edge device(s) 104 when implementing reporting, offloading, and transmission operations based on severity information and/or priority information. Such state information may include, without limitation, computational workload metrics, connectivity type or quality, available bandwidth, power or battery state, system health, and/or current processing load.

For example, the upload controller may evaluate one or more computational workload metrics, such as processor utilization, memory usage, power consumption, or network load, relative to one or more predetermined computational workload thresholds when determining whether, when, or how to transmit an evidence package. In some instances, even when an evidence package is associated with a higher severity level or priority level, the upload controller may delay, throttle, batch, or defer transmission of the evidence package if the computational workload metrics indicate constrained system resources or unfavorable operating conditions.

As described herein, the severity information and/or priority information associated with a detected compliance violation may be determined based at least in part on vehicle information of a vehicle hosting or otherwise associated with the edge device(s) 104, as obtained via a vehicle interface of the edge device(s) 104. For example, a detected compliance violation identified while the vehicle is stationary, operating at low speed, or traveling along a designated inspection route may be assigned a higher severity level or priority level based on increased confidence in the detection. In another example, a detected compliance violation identified while the vehicle is traveling at higher speed, performing a non-inspection route, or operating under transient conditions may be assigned a lower severity level or priority level, reflecting reduced confidence or increased likelihood of transient artifacts.

Based on the severity information and/or priority information determined using vehicle information as described herein, the upload controller (e.g., upload controller 310) may implement corresponding selection, prioritization, and transmission operations within the distributed processing architecture. For example, evidence packages associated with elevated severity or priority levels, such as those resulting from detections made under high-confidence vehicle conditions, may be selected for immediate or near-immediate transmission to cloud server(s) 120, may be transmitted ahead of other pending data, or may trigger offloading of additional processing to cloud-based resources. In contrast, evidence packages associated with lower severity or priority levels, such as those resulting from detections made under lower-confidence vehicle conditions, may be retained locally at the edge device(s) 104 as candidate evidence packages, aggregated with subsequent detections, transmitted in batch, or conditionally promoted for transmission if corroborated by additional detections or improved operating conditions.

Additionally, or alternatively, prior to performing substantive compliance violation detection or context analysis, the distributed processing of the video data and/or image data captured by edge device(s) 104 may be based on computational capabilities or workload metrics of the edge device(s) 104 and/or cloud server(s) 120, as well as, network conditions and/or latency constraints. For example, edge device(s) 104 may monitor computational workload metrics, such as processing time, memory consumption, CPU/GPU utilization, power usage, and data complexity, to determine whether the processes related to a compliance violation detection and/or the processes related to the context analysis exceed a predefined processing threshold. In instances where the processes related to compliance violation detection and/or the processes related to the context analysis are determined to exceed a predefined processing threshold, edge device 104 may offload the processes to cloud server(s) 120 for execution. Cloud server(s) 120 may implement the offloaded processes (e.g., execute AI/ML model(s) to preform object detection, classification, compliance violation determination, context analysis, and/or generation of coherent and contextually relevant language-based content associated with the detected compliance violation).

In some instances, edge device(s) 104 may determine the processes related to compliance violation detection and the processes related to context analysis each exceeds a predefined processing threshold based on the video data and/or image data and computation workload metrics of edge device(s) 104. Edge device 104 may provide the video data and/or image data to cloud server(s) 120. As described herein, object detection system 122 of cloud server(s) 120 may implement processes related to compliance violation detection, such as processing the video data and/or image data to determine whether a compliance violation has occurred. Based on detecting a compliance violation, context system 124 of cloud server(s) 120 may implement processes related to context analysis of the portions of the video data and/or image data associated with the compliance violation (e.g., identified objects, environmental conditions, structures, and/or other visual indicators indicative of the compliance violation) to determine context information, including, but not limited to, the type of violation, the overall severity of the violation, associated timestamp(s), and characteristics of the violation (e.g., levels of damage, cleanliness, maintenance deficiencies). In some instances, processes related to context analysis may include generating content based on the context information. In some cases, cloud server(s) 120 may generate context data including the determined context information and/or the associated content.

In some instances, edge device(s) 104 may determine the processes related to compliance violation detection does not exceed a predefined processing threshold based on the video data and/or image data and computation workload metrics of edge device(s) 104. Moreover, edge device(s) 104 may determine the processes related to context analysis exceeds a predefined processing threshold based on the video data and/or image data and computation workload metrics of edge device(s) 104. In such instances, edge device(s) 104, such as object detection system(s) 122 (e.g., object detection module 301), may implement processes related to compliance violation detection, such as processing the captured video data and/or image data to determine whether a compliance violation is present. For instance, object detection module 301 may use one or more AI/ML models (e.g., object detection model(s)) to determine or detect objects, structures, environmental conditions, and other visual indicators within the video data and/or image data, and based on the portions of the video data and/or image data of the detected objects, structures, environmental conditions, and other visual indicators, whether a compliance violation is present. Based on the detected compliance violation, object detection module 301 may generate the evidence package including, but not limited to, the portions of the video data and/or image data of the detected objects, structures, environmental conditions, and other visual indicators indicative of a compliance violation. Edge device 104 may provide the evidence package to cloud server(s) 120 (e.g., via upload module 212). Context system 124 of cloud server(s) 120 may implement processes related to context analysis on the evidence package to determine or extract context information associated with the detected compliance violation based on the associated evidence package (e.g., the type of violation, overall severity of the violation, characteristics of the violation (e.g., levels of damage, cleanliness, maintenance deficiencies), and associated timestamp(s)). In some instances, processes related to context analysis may include generating content based on the context information. In some cases, cloud server(s) 120 may generate context data including the determined context information and/or the associated content.

In some instances, edge device(s) 104 may determine the processes related to compliance violation detection and the processes related to context analysis each does not exceed a predefined processing threshold based on the video data and/or image data and computation workload metrics of edge device(s) 104. In such instances, edge device 104 may perform both processes related to compliance violation detection and context analysis locally. For instance, edge device 104 may capture video data and/or image data of the region(s) of the local jurisdiction. Object detection module 301 may process the video data and/or image data to determine whether a compliance violation is present (e.g., object detection module 301 may use AI/ML model(s) to determine or detect objects, structures, environmental conditions, and other visual indicators within the video data and/or image data, and based on the portions of the video data and/or image data of the detected objects, structures, environmental conditions, and other visual indicators, whether a compliance violation is present). Based on the detected compliance violation, object detection module 301 may generate evidence package (e.g., data including, but not limited to, the portions of the video data and/or image data of the detected objects, structures, environmental conditions, and other visual indicators indicative of a compliance violation). Based on the evidence package, context analysis module 303 may process the evidence package to determine context information associated with the detected compliance violation (e.g., context analysis module 303 may use AI/ML model(s) to determine context information, such as, but not limited to, the type of violation, overall severity of the violation, characteristics of the violation (e.g., levels of damage, cleanliness, maintenance deficiencies), and corresponding timestamp(s)), as described herein. In some instances, processes related to context analysis may include generating content based on the context information. In some cases, context analysis module 303 may generate context data including the determined context information and/or the associated content.

In some examples, edge device(s) 104, such as object detection module 301, may perform an initial level of object detection and determine whether the complexity of further analysis (e.g., multi-object tracking, high-resolution segmentation, or environmental correlation mapping) requires additional computing power. If so, edge device(s) 104 may selectively offload only the necessary data to cloud server(s) 120 while maintaining local control over lower-complexity processing. Furthermore, edge device(s) 104 may employ adaptive processing strategies, wherein certain compliance violation types (e.g., those with historically high computational demands) are automatically flagged for processing by cloud server(s) 120 to optimize power efficiency and system performance.

In some aspects, edge device(s) 104 may determine whether to offload one or more processes (e.g., compliance violation detection processes and/or context analysis processes) to cloud server(s) 120 based on a detection of a compliance violation. For example, edge device 104 may detect a compliance violation locally based on video data and via one or more AI/ML models. Based on detecting the compliance violation, edge device 104 may prioritize real-time processing when local resources and/or computational capabilities are sufficient, or may offload more complex or computationally intensive analyses, such as processes related to context information determination associated with the compliance violation, to cloud server(s) 120, which may provide greater computational capacity and available processing resources.

Additionally, or alternatively, edge device(s) 104 may determine whether to offload the one or more processes (e.g., compliance violation detection processes and/or context analysis processes) to cloud server(s) 120 based on one or more context factors. As described herein, context factor(s) may include, but are not limited to, environmental contexts, situational contexts, context factors or a combination thereof. Examples of context factors may include, without limitation, location-based factors (e.g., the edge device may offload one or more processes when operating in critical infrastructure zones, high-risk areas, or regulatory enforcement regions, because such locations may require higher compliance scrutiny necessitates and therefore more robust processing capabilities), weather condition factors (e.g., adverse weather conditions, such as heavy rain, snowfall, fog, or extreme temperatures, may degrade local processing accuracy, prompting the offloading of compliance violation detection processes and/or context analysis processes to a more capable computing system), seasonal factors (e.g., time-based environmental changes, such as increased waste accumulation in autumn, icy road conditions in winter, or higher pedestrian density in summer, may influence compliance detection requirements, causing the edge device to offload processing to a more capable computing system), lighting condition factors (e.g., variations in ambient lighting levels, such as, but not limited to, nighttime conditions, overcast weather, or shadowed areas, may affect object detection performance, prompting offloading to a more capable computing system with enhanced image or object detection processing and context analysis capabilities), environmental factors (e.g., population density (high vs. low foot traffic in public spaces), traffic density (high vs. low vehicular congestion), and building density (urban vs. suburban environments) may impact compliance violation detection analysis and may cause the edge device to offload processing when these factors increase computational complexity). Based on one or more detected context factors or a combination thereof, edge device 104 may determine whether its local processing resources and computational capabilities are sufficient to perform compliance violation detection and/or context information determination, or whether such processing should be offloaded to cloud server(s) 120, which may provide greater computational capacity and available processing resources.

In some instances, edge device 104 may use additional data sources (e.g., location data, sensor inputs from environmental and light sensors, time-based metadata, image exposure data, etc.) to determine the context factor(s). Additionally, or alternatively, edge device 104 may use other AI/ML model(s) to determine the environmental context(s), situational context(s), context factor(s), or a combination thereof.

In some cases, cloud server(s) 120 may generate one or more notifications for relevant recipient(s) based on the evidence package and/or the context data (e.g., the context information and/or the associated content). As illustrated in FIG. 3A, and in some configurations, cloud server(s) 120 may include notification engine 320 configured to generate the notification(s) based on the evidence package and/or the context data. Moreover, the notification(s) may characterize the nature of the compliance violation. In some instances, the evidence package and/or associated context data may include severity information and/or priority information determined by edge device 104 (e.g., severity engine 308). In such instances, the notification(s) may include details of the compliance violation, such as the overall severity of the violation, the type of violation, the location of the compliance violation, etc. In some configurations, notification engine 320 may maintain an audit record or decision trace indicating how severity information, priority information, spatial clustering information, and policy information contributed to notification prioritization and recipient selection.

In some aspects, cloud server(s) 120 may generate recommendations regarding management and resolution of the detected compliance violation. In some configurations, context system(s) 124 of cloud server(s) 120 may generate the recommendation(s). For instance, context system(s) 124 may use AI/ML model(s) (e.g., generative AI/ML model(s)) to determine recommended processes to resolve or manage the detected compliance violation based on the severity information and/or priority information, applicable rule information and/or policy information, and/or portion(s) of the evidence package and/or associated context data. In some configurations, the rule information and/or policy information may be obtained from a cloud-side policy/rule store, such as policy/rule store 322, which may define jurisdiction-specific remediation procedures, response timelines, escalation criteria, or responsible parties for different categories of compliance violations.

For example, based on an evidence package and associated context data indicating an overfilled trash bin within a monitored public area, context system(s) 124 may retrieve policy information from policy/rule store 322 specifying waste management service thresholds, cleanup response timelines, or escalation rules applicable to sanitation-related compliance violations. Using the retrieved policy information together with severity information indicating that the overfilled trash bin poses a public health concern or repeated non-compliance condition, context system(s) 124 may generate a recommendation that includes, without limitation, dispatching a sanitation crew within a defined response time window, increasing collection frequency for the affected location, and notifying a municipal waste management authority.

Based on the determined recommended processes, context system(s) 124 may generate content related to the recommended management and resolution actions. Moreover, notification engine 320 may obtain the content and include the content into the notification(s) transmitted to relevant recipients. In instances where edge device(s) 104 generates the context data for a detected compliance violation, edge device(s) 104 may provide the context data, and in some instances the evidence package including associated severity information and/or priority information, to cloud server(s) 120. Cloud server(s) 120 (e.g., notification engine 320) may generate the notification(s) based on the context data and/or evidence package.

In some examples, cloud server(s) 120, such as notification engine 320, may determine recipient(s) of the notification(s), such as contractors and/or agencies responsible for addressing the detected or determined compliance violation, based on the detected or determined compliance violation and/or the associated context information. For example, notification engine 320 may process the evidence package and/or associated context data to identify compliance violation characteristic(s), such as, but not limited to, the type of compliance violation (e.g., traffic control infrastructure, waste management, accessibility-related infrastructure), the location of the violation, and the associated severity information and/or priority information. Cloud server(s) 120 may transmit the notifications to the relevant recipients to facilitate corrective actions.

Moreover, cloud server(s) 120 may determine the recipient(s) based on policy information and/or rule information. Based on the identified compliance violation characteristic(s) and the applicable policy information and/or rule information, cloud server(s) 120 may select one or more appropriate recipients for notification. For example, for a detected compliance violation involving a fallen stop sign classified as a safety-critical traffic control infrastructure issue within a municipal roadway jurisdiction, the policy information may indicate that such violations are to be reported to a city transportation agency and an associated roadway maintenance contractor. Based on this policy information, notification engine 320 may select the city transportation agency system and the roadway maintenance contractor system as recipients of the corresponding notification.

In some instances, the cloud server(s) 120 may obtain the policy information and/or rule information from a policy/rule store associated with cloud server(s) 120 (e.g., policy/rule store 322). Further, the policy information and/or rule information stored in a policy/rule store of edge device(s) 104 (e.g., policy/rule store 208) may be based on, derived from, or periodically updated using the policy information and/or rule information maintained in the cloud-side policy/rule store 322. In such instances, cloud server(s) 120, such as notification engine 320, may consistently determine relevant recipients for notifications across multiple edge devices and monitored jurisdictions while ensuring that notification routing aligns with current jurisdictional responsibilities and enforcement policies.

In some configurations, cloud server(s) 120 (e.g., notification engine 320) may use one or more AI/ML model(s) (e.g., generative AI/ML model(s) and/or agentic AI/ML model(s)) to determine the appropriate recipients for a notification. For example, notification engine 320 may use the AI/ML model(s) to analyze historical compliance records, prior notification outcomes, jurisdictional responsibility data, or contractor performance data to refine or validate recipient selection. In some cases, notification engine 320 may use the AI/ML model(s) in combination with policy information and/or rule information to resolve ambiguities, prioritize among multiple potential recipients, or adapt recipient selection based on evolving jurisdictional practices.

In some cases, the cloud server(s) 120 may prioritize certain notifications of detected compliance violations based on location information of detected compliance-related objects, severity information, priority information, policy information and/or rule information. In some configurations, such prioritization determinations may be performed by notification engine 320. Additionally, or alternatively, such prioritization determinations may be based on spatial clustering of compliance violations across a monitored jurisdiction. As described herein, the spatial clustering of compliance violations may be determined based on location information of the compliance-related objects across a monitored jurisdiction.

For example, cloud server(s) 120 and/or edge device(s) 104 may process context data associated with multiple detected compliance violations to extract or obtain location information corresponding to each related or associated compliance-related object(e.g., geographic coordinates, geospatial metadata, or mapped positions). Based on the location information of each compliance-related object, notification engine 320 may determine spatial relationships between the detected compliance violations, such as relative proximity, co-location within a geographic region, or occurrence within a predetermined distance or area threshold. Based on the spatial relationships between the detected compliance violations, notification engine 320 may identify spatial clusters of compliance violations occurring within the same geographic region. Moreover, policy information and/or rule information may specify that spatially clustered compliance violations of certain types or occurring within designated zones (e.g., school zones, high-traffic corridors, or critical infrastructure areas) warrant elevated priority, coordinated handling, or aggregated reporting.

Additionally, or alternatively, one or more of the location-based analysis, spatial relationship determination, and spatial clustering operations described herein may be performed by edge device(s) 104, such as upload module 212, and notification engine 320. For example, upload module 212 may evaluate location information associated with multiple evidence packages and/or associated context data to determine whether the corresponding compliance violations are spatially related, such as occurring within a common geographic region or within a predetermined distance or area threshold. Based on the determined spatial clustering information, upload module 212 may identify a set of related evidence packages corresponding to compliance violations that are spatially associated. Upload module 212 may then correlate information across the identified evidence packages to determine shared attributes, such as common location characteristics, temporal proximity, violation type, or other contextual similarities. Based on the correlated information, upload module 212 may associate one or more cluster indicators, preliminary priority adjustment indicators, and/or aggregated context data with the related evidence packages. The associated cluster indicators and aggregated context data may then be provided to cloud server(s) 120, such as notification engine 320, for downstream processing. For instance, notification engine 320 of cloud server(s) 120 may use the cluster indicators, aggregated context data, and applicable policy information and/or rule information to determine notification prioritization or coordinated notification workflows for the clustered compliance violations.

In some aspects, cloud server(s) 120 may prioritize notifications based on the severity information and/or priority information of the compliance violation, including, but not limited to, the severity information and/or priority information associated with spatially clustered violations. In some configurations, such prioritization may be determined by notification engine 320. As described herein, the severity information and/or priority information may be determined by a severity engine, such as severity engine 308, based on evidence package data, context data, and applicable rule information and/or policy information. For example, notification engine 320 may prioritize transmitting notifications of compliance violations that were determined to have an overall severity greater than a predetermined threshold severity level (e.g., a value corresponding to the predetermined threshold severity level). In some instances, the predetermined threshold severity/priority level may be defined or adjusted based on policy information specifying enforcement priorities, jurisdictional constraints, or escalation rules.

In some configurations, cloud server(s) 120, such as notification engine 320, may dynamically adjust the predetermined threshold severity level based on real-time conditions, jurisdictional policies, or resource availability of agencies and contractors responsible for addressing compliance violations. For example, if a government agency or contractor is currently handling an active compliance violation, the cloud servers 120 may temporarily adjust the prioritization criteria to optimize resource allocation and prevent overload of enforcement or maintenance personnel.

In some instances, cloud server(s) 120, such as notification engine 320, may be configured to prioritize notifications associated with detected compliance violations based on the severity information and/or priority information of each compliance violation and the time frame within which multiple compliance violations are identified. For example, notification engine 320 may determine, based on context data of each of the detected violations, a timestamp associated with each of the multiple compliance violations were detected. Notification engine 320 may determine a set of the multiple detected compliance violations that were detected for a particular predetermined time threshold or period based on the associated timestamp. Based on the context data of each of the set of detected compliance violations, notification engine 320 may determine, for each of the set of detected compliance violations, severity information and/or priority information, such as an overall severity level. In some instances, the severity information and/or priority information may reflect rule-based escalation criteria or policy-defined urgency thresholds. Based on the severity information and/or priority information of each of the set of detected compliance violations, notification engine 320 may determine an order of priority for transmitting the corresponding notifications (e.g., notifications of compliance violations with the highest or higher levels of overall severity may be transmitted first).

In some examples, cloud server(s) 120, such as notification engine 320, may be configured to prioritize notifications of detected compliance violations of a specific type that are frequently reported and remain unresolved over time. Moreover, the frequency-based prioritization may be based on historical compliance data and/or policy information and/or rule information, such as policy-defined escalation rules. In such examples, cloud server(s) 120 may increase the priority level of notifications of such compliance violations. For example, policy information may specify that repeated occurrences of a particular compliance violation type within a defined time window or geographic area warrant escalation, increased reporting frequency, or coordinated remediation actions. Based on such policy information, notification engine 320 may increase a priority level associated with the notification, modify a transmission order or urgency indicator, trigger generation of an escalated notification type, and/or route the notification to additional or higher-authority recipients to facilitate timely resolution.

As illustrated in FIG. 3, and in some configurations, cloud server(s) 120 may further include an upload module 325. Upload module 325 may be configured to manage transmission of notifications to the relevant recipients based on notification prioritization and recipient determinations. As described herein, upload module 325 may operate in coordination with notification engine 320, which determines notification content, priority levels, escalation state, and intended recipients based on severity information, priority information, spatial clustering information, policy information, and/or rule information. Based on the outputs of notification engine 320, upload module 325 may implement transmission operations for notifications, including selecting appropriate communication channels, ordering notification delivery based on priority, batching notifications for coordinated delivery, retrying failed transmissions, or deferring notification delivery based on system state or recipient availability.

In some cases, cloud server(s) 120 may implement one or more resolution assessment processes to assess whether the identified or determined compliance violation(s) have been resolved within a timely manner. As illustrated in FIG. 3A, and in some configurations, cloud server(s) 120 may include resolution module 328. Resolution module 328 may be configured to manage and execute such resolution assessment processes. For instance, based on a detection of a compliance violation, resolution module 328 may initiate a resolution assessment process. In some configurations, cloud server(s) 120, such as, resolution module 328, may determine whether and when to initiate a resolution assessment processes based on policy information and/or rule information obtained from a cloud-side policy/rule store (e.g., policy/rule store 322). Additionally, or alternatively, cloud server(s) 120, such as, resolution module 328, may determine specific resolution assessment process or processes to implement based on the policy information and/or rule information.

As described herein, examples of such policy information and/or rule information include, but are not limited to, policy-defined resolution timelines, re-inspection intervals, escalation criteria associated with particular types of compliance violations, and directives specifying resolution verification mechanisms, such as whether resolution is to be assessed via follow-up mobile inspection, scheduled re-capture by passing edge device(s) 104, targeted redeployment of inspection assets, or longitudinal monitoring over multiple time intervals. In some instances, the resolution assessment processes may be performed as part of longitudinal tracking of compliance conditions over time.

For instance, and based on policy information and/or rule information, the resolution assessment processes may include initiating the deployment of an additional asset(s) (e.g., non-autonomous vehicles, autonomous vehicles, robots, drones, etc.) equipped with edge device(s) 104 including the optical sensors, to the location of the detected compliance violation. Such policy information and/or rule information may specify that a follow-up inspection via redeployment is required for particular types of compliance violations, severity levels, or resolution timelines. Edge device(s) 104 of the additional asset(s) may capture new video data and/or image data of the location of the detected compliance violation. Edge device(s) 104 and/or cloud server(s) 120 may process the new video data and/or image data to determine whether the compliance violation has been addressed. For instance, edge device(s) 104 and/or cloud server(s) 120 may apply one or more AI/ML models (e.g., object detection model(s)) on the video data and/or image data to determine whether the compliance violation has been addressed, as described herein.

In some aspects, the resolution assessment processes may include processing video data and/or image data that were captured after the compliance violation was detected to determine whether the compliance violation has been addressed. In some configurations, such longitudinal evaluation may be coordinated by resolution module 328 based on policy-defined verification windows or rule-based follow-up schedules stored in policy/rule store 322. For instance, edge device(s) 104 and/or cloud server(s) 120 may apply one or more AI/ML models (e.g., object detection model(s)) on the video data and/or image data captured after the compliance violation was detected to determine whether the compliance violation has been addressed, as described herein. In some instances, the video data and/or image data may have been captured by other edge device(s) 104 that were equipped or included on asset(s) that were passing by the detected compliance violation after the compliance violation was detected.

In some cases, the resolution assessment processes may include processing video data and/or image data of edge device(s) 104 that were captured a predetermined time interval after the compliance violation was detected to determine whether the compliance violation has been addressed. In some configurations, the predetermined time interval may be specified by policy information and/or rule information maintained in policy/rule store 322. For instance, edge device(s) 104 and/or cloud server(s) 120 may apply one or more AI/ML models (e.g., object detection model(s)) on the video data and/or image data that were captured the predetermined time interval after the compliance violation was detected to determine whether the compliance violation has been addressed, as described herein. As similarly described above, the video data and/or image data may have been captured by other edge device(s) 104 that were equipped or included on asset(s) that were passing by the detected compliance violation after the compliance violation was detected.

In examples where the compliance violation remains unresolved, edge device(s) 104 and/or cloud server(s) 120, including resolution module 328, may use AI/ML model(s), such as generative AI model(s), to determine whether the compliance violation has worsened since its initial detection and/or to extract updated characteristics of the unresolved compliance violation. In some configurations, such determination may be performed relative to policy-defined degradation thresholds or escalation criteria specified in policy information and/or rule information maintained in policy/rule store 322. Moreover, cloud server(s) 120 may perform compliance violation tracking and archival, including, but not limited to, longitudinal tracking of unresolved compliance violations, maintaining structured records of unresolved compliance violations for future analysis, trend identification, and predictive compliance enforcement. In some configurations, resolution module 328 may manage such longitudinal records and evaluate escalation conditions based on policy information and/or rule information stored in policy/rule store 322.

In some instances, cloud server(s) 120, such as notification engine 320, may implement reporting processes to relevant agencies and/or contractors associated with unresolved detected compliance violation. Such reporting processes may include, but are not limited to, providing additional notifications of the compliance violation or unresolved compliance violation, escalating notifications of the compliance violation or unresolved compliance violation, and/or triggering further actions to ensure timely resolution by the relevant agency or agencies or contractor(s). For example, notification engine 320 may generate escalated notifications, route notifications to additional or higher-authority recipients, or increase notification urgency based on escalation conditions identified by resolution module 328, such as persistent non-resolution, violation worsening, or policy-defined escalation triggers (e.g., re-dispatching inspection resources, scheduling reinforcement actions, or initiating contractor performance reviews).

In some configurations, edge device(s) 104 and/or cloud server(s) 120 may include mechanisms for reducing computational load, bandwidth consumption, and power usage associated with continuous analysis of video data and/or image data. In some examples, one or more of such mechanisms may include selectively identifying and analyzing only a subset of video frames or images from the captured video data or image data that are more likely to contain compliance-relevant information (e.g., compliance-related objects or objects of interest) rather than uniformly processing all captured video data and/or image data.

As illustrated in FIG. 3A, object detection system 122 may include a frame-of-interest (FOI) selection module 302. FOI selection module 302 may be configured to determine frames of interest from video data captured by edge device(s) 104 and/or images of interest from image data captured by edge device(s) 104. Frames or images of interest may include or capture one or more compliance-related objects, structures, environmental conditions, or other visual indicators relevant to compliance monitoring, as described herein. The identified frames or images of interest may then be provided to object detection module 301 for further processing. For example, object detection module 301 may process the frames or images of interest to identify one or more compliance-related objects, structures, environmental conditions, and/or other visual indicators depicted therein. Moreover, based on the detected objects, structures, environmental conditions, and/or other visual indicators, object detection module 301 may determine or detect an occurrence of a compliance violation. In this manner, object detection system 122 may selectively apply visual analysis to frames or images of interest rather than to all captured visual data, thereby reducing overall computational workload.

In some examples, object detection system 122 may use one or more AI/ML models to identify or assist in identifying frames or images of interest. For example, FOI selection module 302 may execute, or cause execution of, one or more AI/ML models, such as a vision encoder, lightweight object detection model, or other vision model, to analyze captured video data and/or image data and determine which frames or images are likely to include compliance-related objects or other compliance-relevant visual content. In such configurations, more computationally intensive AI/ML-based visual analysis may be selectively applied by object detection module 301 to the identified frames or images of interest, for example to detect or classify compliance-related objects, structures, environmental conditions, or other visual indicators and to determine, based thereon, whether a compliance violation has occurred.

In some cases, frame-of-interest (FOI) selection module 302 may determine frames or images of interest based at least in part on policy information and/or rule information associated with compliance-related objects or objects of interest. As described herein, the policy information and/or rule information may be obtained from a policy/rule store accessible to edge device(s) 104 (e.g., policy/rule store 208). Moreover, the policy information and/or rule information may specify one or more compliance-related objects that are designated as objects of interest. For example, the policy information and/or rule information may indicate that certain compliance-related objects are of higher importance than others, such as, but not limited to, safety-critical infrastructure assets, accessibility-related features, or objects that are historically problem-prone or frequently associated with compliance violations. Additionally, or alternatively, the policy information and/or rule information may include, reference, or be associated with location information of such compliance-related objects, including, but not limited to, expected or known geographic positions within a monitored jurisdiction.

In some aspects, FOI selection module 302 may determine frames or images of interest based on a relative spatial relationship between a vehicle hosting edge device(s) 104 and one or more compliance-related objects or objects of interest. In such aspects, FOI selection module 302 may obtain location information of the vehicle from one or more sources, including a vehicle interface communicatively coupled to the edge device(s) 104 (e.g., vehicle interface 305) and/or a location device of the edge device(s) 104 (e.g., an RTK-enabled GNSS receiver). Moreover, FOI selection module 302 may obtain location information associated with compliance-related objects or objects of interest from policy information and/or rule information stored in a policy/rule store (e.g., policy/rule store 208), as described herein. As described herein, the location information of the compliance-related objects or objects of interest from may represent known, expected, or previously mapped geographic positions of compliance-related objects within a monitored jurisdiction. Based on the location information of the vehicle and the location information of the compliance-related objects or objects of interest, FOI selection module 302 may determine a position of the vehicle relative to the position of the compliance-related object, including distance, approach direction, and relative motion. The determined relative spatial relationship may then be evaluated against one or more proximity distance thresholds, directional criteria, and/or motion-based conditions defined by applicable policy information and/or rule information to support determination of frames or images of interest.

In online or driving scenarios, FOI selection module 302 may dynamically determine frames or images of interest while the vehicle is in motion based on a spatial relationship between the vehicle hosting edge device(s) 104 and one or more compliance-related objects of interest. Based on vehicle location information and compliance-related object location information obtained from policy/rule store 208, FOI selection module 302 may determine whether the vehicle is within a proximity distance threshold of a compliance-related object, as defined by applicable policy information and/or rule information.

For example, policy information may identify a particular stop sign as a compliance-related object of interest, location information of the stop sign, and/or an associated proximity distance threshold associated with frames or images of interest selection. While the vehicle is driving, FOI selection module 302 may monitor the vehicle's location with respect to the location of the stop sign based on the location information of the vehicle and the location information of the stop sign. Based on the monitored vehicle's location with respect to the location of the stop sign and the proximity distance threshold, FOI selection module 302 may determine whether the vehicle is within the proximity distance threshold to the stop sign and, in some instances, a spatial relationship between the vehicle and the stop sign, such as the distance between the vehicle and the stop sign and/or a direction or trajectory the vehicle is traveling relative to the stop sign. Based on one or more of such determinations, FOI selection module 302 may select frames or images of interest captured by edge device(s) 104 and/or increase or decrease the sampling frequency and/or resolution of the selected frames or images. For instance, when the vehicle enters a defined proximity distance threshold, FOI selection module 302 may begin selecting frames or images of interest captured by edge device(s) 104. As the vehicle continues to approach the stop sign, FOI selection module 302 may increase the sampling frequency or resolution of selected frames or images. After the vehicle passes the stop sign and moves outside the proximity distance threshold, FOI selection module 302 may reduce sampling frequency or cease detailed frame selection associated with that object.

In some instances, when the vehicle is traveling through an area where no policy-identified compliance-related objects are nearby (e.g., an ordinary empty block), FOI selection module 302 may select few or no frames beyond basic recording, thereby reducing unnecessary computational workload.

In some examples, FOI selection module 302 determine frames or images of interest based on vehicle state information and a relative spatial relationship between a vehicle hosting edge device(s) 104 and one or more compliance-related objects or objects of interest. As described herein, vehicle state information may be obtained via vehicle interface 305 and may include, without limitation, vehicle speed, acceleration or deceleration, braking activity, steering activity, ignition state, and whether the vehicle is stationary or in motion. The vehicle state information may be evaluated in combination with proximity-based determinations, as described herein. For example, when a vehicle is within a proximity distance threshold of a compliance-related object of interest and is moving toward the location of the object at a relatively slow speed, FOI selection module 302 may increase the frequency at which frames or images are selected for analysis. Conversely, if the vehicle is within the proximity distance threshold but is moving away from the object or traveling at a higher speed, FOI selection module 302 may reduce sampling frequency or limit detailed analysis, reflecting reduced inspection confidence or diminished opportunity for high-quality capture.

By way of example, policy information may identify an overfilled trash receptacle as a compliance-related object of interest and may include location information and applicable proximity distance thresholds associated with inspection or capture requirements. While the vehicle is driving, FOI selection module 302 may monitor vehicle state information obtained via vehicle interface 305 together with the vehicle's location relative to the location of the trash receptacle. Based on such monitoring, FOI selection module 302 may determine whether the vehicle is within a proximity distance threshold of the trash receptacle and may further evaluate vehicle state information, such as vehicle speed, deceleration, or stopping behavior. For instance, when the vehicle slows down or decelerates while approaching the overfilled trash receptacle within the proximity distance threshold, FOI selection module 302 may increase the sampling frequency or resolution of selected frames or images to capture clearer and more detailed visual data of the receptacle. Conversely, if the vehicle accelerates away from the trash receptacle, moves outside the proximity distance threshold, or is traveling at a higher speed indicative of reduced inspection opportunity, FOI selection module 302 may reduce the sampling frequency or terminate detailed frame or image selection associated with that compliance-related object.

In some cases, determination of frames or images of interest may be performed offline or when the vehicle is not actively driving. In such cases, video frames or images captured by edge device(s) 104 may include associated metadata, such as timestamps, vehicle location information, and vehicle state information at the time of capture. Moreover, FOI selection module 302 may process or analyze such metadata after capture to determine the vehicle's position relative to compliance-related objects of interest using the same policy-defined object importance and proximity-based criteria described herein. In this manner, FOI selection module 302 may retroactively identify frames or images of interest for further analysis, even if detailed analysis was not performed in real time. This enables deferred or batch processing of visual data, supports post-route compliance verification, and allows computationally intensive analysis to be scheduled during periods of lower system load or offloaded to cloud-based resources, as described elsewhere herein.

For example, during offline processing, FOI selection module 302 may process stored video data and/or image data captured during a prior inspection route and associated metadata, including, but not limited to, timestamps, vehicle location information, and vehicle state information. Moreover, associated policy information (e.g., obtained from policy/rule store 208) may identify debris in the roadway as a compliance-related object of interest and may include known or expected location information for such objects (e.g., historically reported debris locations or mapped high-risk roadway segments). Based on the metadata associated with the stored video data and the policy-defined location information, FOI selection module 302 may determine time intervals during which the vehicle was within a proximity distance threshold of a roadway segment associated with potential debris. Moreover, FOI selection module 302 may select frames or images captured during those time intervals as frames or images of interest for further analysis. Further, FOI selection module 302 may evaluate vehicle state information, such as reduced vehicle speed or braking activity, recorded in the metadata to increase confidence that the captured frames correspond to a meaningful inspection opportunity. Based on such determinations, FOI selection module 302 may prioritize the selected frames or images relative to other captured frames or images for subsequent object detection processing and/or context analysis processing by object detection system 122 and/or context system(s) 124.

In some examples, the AI/ML algorithm(s) or model(s) described herein and implemented by context system(s) 124, such as context analysis module 303, may be configured to process, analyze and/or interpret evidence packages and/or associated context data generated by object detection system 122. In some configurations, such AI/ML model(s) may include, but are not limited to, vision-language model(s) (VLM) configured to jointly process visual information derived from sensor data (e.g., video data and/or image data) of region(s) of the local jurisdiction together with language-based, semantic, or contextual representations. Moreover, the VLM may be configured to determine, infer, or generate contextual information associated with a detected compliance violation based on the evidence package. As described herein, the context information may, include, but is not limited to, characterization of the compliance violation, environmental or situational context (e.g., weather conditions, surrounding objects, time of day, location information), severity-related attributes, and/or language-based summaries or descriptions.

In some cases, the VLM may be domain specific. As described herein, a domain-specific VLM refers to a model that is trained, fine-tuned, or otherwise adapted to operate within a defined application domain or problem space, rather than serving as a general-purpose visual understanding model. Such a domain may correspond to a particular industry, operational environment, regulatory framework, or task category for which specialized visual-semantic reasoning is desirable. In some instances, and as described throughout the present disclosure, the domain may correspond to a compliance monitoring domain, such as, but not limited to, municipal infrastructure compliance, public safety enforcement, environmental condition monitoring, accessibility compliance, or waste management. However, it is to be appreciated that the techniques described herein are not limited to compliance monitoring and may be applied to other domains, including, and without limitation, industrial inspection, facility management, transportation safety, construction monitoring, logistics operations, agricultural monitoring, or retail environment analysis. As described herein, the domain-specific VLM may be optimized to recognize, interpret, and reason about a constrained and domain-relevant set of objects (e.g., compliance-related objects), conditions, events, and semantic relationships, thereby enabling more efficient and reliable generation of actionable classifications, summaries, or recommendations tailored to the target domain (e.g., compliance monitoring domain).

Additionally, or alternatively, the VLM implemented by context system(s) 124 may be quantized to reduce computational complexity, memory footprint, and inference latency. In such configurations, quantization may be applied to one or more components of the VLM, including vision encoders, language encoders, or multimodal fusion layers, such that the VLM operates in a reduced-precision representation while maintaining acceptable compliance-detection performance. In some instances, the reduced-precision representation may be selected to support generation of coarse but actionable classifications that are sufficient for enforcement decision-making, rather than detailed visual reconstructions or fine-grained damage scoring outputs.

In this manner, the quantized VLM may support efficient and scalable deployment of context system(s) 124 for compliance monitoring by prioritizing determination of whether a detected condition represents a compliance issue that merits enforcement, reporting, escalation, or follow-up. By focusing on coarse but actionable classifications, the quantized VLM may enable timely decision-making at inference time at reduced computational cost, while deferring more computationally intensive, high-resolution, or fine-grained analysis to higher-capacity cloud-based models when warranted.

As described herein, coarse but actionable classifications may be sufficient to determine whether a detected condition warrants enforcement, reporting, escalation, or further analysis, while reducing computational complexity and inference latency. For example, for a compliance monitoring domain, the VLM may generate discrete classification outputs such as, but not limited to, a trash receptacle being classified as empty, normal, or overflowing; a traffic sign being classified as clear, blocked, bent, or missing; a roadway surface being classified as clear or obstructed by sand or water; or a crosswalk being classified as faded or freshly marked. The coarse but actionable classifications may be used by downstream components to trigger notifications, prioritize inspections, initiate resolution workflows, or flag the detected condition for additional analysis by higher-capacity cloud-based models, as described herein.

In some aspects, context system(s) 124 may include a training module 304 configured to support training, fine-tuning, or adaptation of a vision-language model (VLM) for operation within a defined application domain. FIG. 3B illustrates a training framework 350 for training, fine-tuning, or adapting the VLM for operation within such a defined application domain. In some instances, training framework 350 may be coordinated by training module 304. As described herein, the training framework 350 may be implemented at cloud server(s) 120 and coordinated by training module 304 to train or adapt the VLM to generate semantically meaningful, domain-relevant, and coarse but actionable classifications from reduced-resolution visual inputs and domain-grounded textual prompts, thereby enabling efficient and reliable context analysis within the target domain.

In some instances, and as described throughout the present disclosure, the defined application domain may correspond to a compliance monitoring domain, such as, but not limited to, municipal infrastructure compliance, public safety enforcement, environmental condition monitoring, accessibility compliance, or waste management. However, it is to be appreciated that the techniques described herein are not limited to compliance monitoring and may be applied to other domains, including, and without limitation, industrial inspection, facility management, transportation safety, construction monitoring, logistics operations, agricultural monitoring, or retail environment analysis.

As illustrated in FIG. 3B, training module 304 may implement training framework 350 configured to train components of the VLM, including, but not limited to, vision encoder 354, text encoder 358, similarity/fusion module 360, and classifier head 362. In some examples, vision encoder 354 may be configured to process visual inputs and generate image embeddings or visual feature representations based on the visual inputs. In some configurations, vision encoder 354 may comprise a lightweight or efficiency-optimized neural network architecture, such as, but not limited to, MobileNet, MobileNetV3, MobileViT, or other compact convolutional or transformer-based vision models. As described herein, vision encoder 354 may be trained or fine-tuned to extract visual features that are semantically meaningful within a target application domain, including features associated with compliance-related objects, structures, environmental conditions, or other visual indicators relevant to compliance monitoring.

During training, vision encoder 354 may obtain visual inputs from storage/buffers 326, such as image bank 352. Storage/buffers 326 may store image crops or cropped images corresponding to regions of interest that include compliance-related objects or objects of interest. In some instances, the cropped images may be obtained from object detection system(s) 122, such as object detection module 301 and/or frame-of-interest selection module 302. Moreover, the cropped images or image crops may correspond to compliance-related objects that were previously detected or determined to be associated with compliance violations.

In some configurations, the cropped images stored in image bank 352 may be saved at multiple resolutions, including low-resolution representations (e.g., 128×128 or 160×160), to support training of vision encoder 354 under reduced-resolution or quantization-aware conditions. Training on such cropped images may enable the VLM to operate effectively within a domain-specific setting by learning to recognize and characterize compliance-related objects using limited visual context and reduced input resolution, consistent with the computational efficiency goals described herein.

In some aspects, text encoder 358 may be configured to process textual inputs and generate corresponding text embeddings. In some configurations, text encoder 358 may comprise a lightweight language model or text embedding model, such as, but not limited to, TinyBERT, MobileBERT, MobileCLIP, or other compact transformer-based architectures. As described herein, text encoder 358 may be trained or fine-tuned to generate embeddings that represent domain-specific semantic concepts relevant to compliance monitoring, including asset types, condition descriptors, and contextual modifiers.

During training, text encoder 358 may obtain domain-specific prompts from storage/buffers 326, such as domain-specific prompt bank 356. Storage/buffers 326 may include short, structured prompts curated or generated by training module 304 based on policy information and/or rule information, such as municipal compliance documents (e.g., inspection guidelines, standard operating procedures, service-level agreements (SLAs), or enforcement rules), stored in policy/rule store 208. In some configurations, training module 304 may perform manual and/or automated processing of the municipal compliance documents to curate and define a domain-specific prompt vocabulary from which the prompts stored in storage/buffers 326 are generated. For example, training module 304 may apply named entity recognition (NER) and phrase-mining techniques to the municipal compliance documents to extract structured and domain-specific concepts or vocabulary from unstructured text, including, without limitation, compliance-related object types (e.g., trash bin, bus shelter, traffic sign, utility pole, crosswalk, drainage inlet), status or condition descriptors (e.g., overflowing, damaged, obstructed, missing, faded, covered), and contextual modifiers (e.g., near curb, at intersection, near school zone, blocking bike lane, near storm drain). Additionally, or alternatively, training module 304 may apply large language models (LLMs) to the municipal compliance documents to extract the domain-specific concepts or vocabulary (e.g., using extraction-oriented prompts or structured output formats, such as asset-condition-location tuples). The LLMs may enable training module 304 to support rapid construction of domain-relevant prompt vocabularies aligned with enforcement or inspection tasks.

In some configurations, training module 304 may apply template patterns to the extracted prompt vocabulary to generate concise and repeatable prompts stored in Storage/buffers 326. Example template patterns may include, without limitation, “[compliance-related object] is [status],” “[status] [compliance-related object] near [location],” or “[context issue] with [compliance-related object].” Example prompts generated using such templates may include, without limitation, “trash bin overflowing with garbage,” “graffiti on bus shelter panel,” “sand accumulation near curb,” “faded crosswalk at intersection,” or “tree branches blocking stop sign.” In some instances, prompts stored in domain-specific prompt bank 356 may be tagged with additional metadata, such as severity level (e.g., low/medium/high), compliance category (e.g., waste, traffic, pedestrian safety, etc.), routing flags (e.g., real-time alert versus deferred handling), model confidence flags, or policy reference identifiers mapping back to specific regulations, inspection rules, or SLAs.

In some cases, similarity/fusion module 360 may receive visual embeddings generated by vision encoder 354 and text embeddings generated by text encoder 358, during training. Moreover, similarity/fusion module 360 may determine or generate alignment information indicating a degree of similarity between visual inputs of the visual embeddings and domain-specific prompts of the text embeddings. In some configurations, the similarity/fusion module 360 may implement cosine similarity, dot-product comparison, or a lightweight neural network to determine multimodal alignment.

In some instances, and during training, the text embeddings provided to similarity/fusion module 360 may correspond to pre-encoded prompt embeddings generated in advance by text encoder 358 from domain-specific prompts stored in domain-specific prompt bank 356. By pre-encoding the prompt embeddings, text encoder 358 may reduce repeated text encoding operations and enable similarity/fusion module 360 to focus on computing alignment between visual embeddings and the pre-encoded text embeddings. This configuration allows training module 304 to efficiently evaluate visual-text alignment by encoding only the image data during training iterations, thereby reducing computational overhead, improving training throughput, and supporting scalable domain-specific training using large prompt vocabularies.

In some aspects, and during training, classifier head 362 may determine a best-matching prompt for each cropped image based on the corresponding alignment information. The selected prompt may serve as a context classification label (e.g., “damaged signage” or “overflowing trash bin”). In some instances, the classifier head 370 may include a lightweight neural network or may simply select the prompt with the highest similarity score. As described herein, such context classifications may correspond to the coarse but actionable classifications generated by the VLM during runtime inference.

Referring back to FIG. 3A, edge device 104 may include inference optimization module 306 configured to control, schedule, select, or modify execution of one or more AI/ML models and/or encoders of object detection system 122 (e.g., object detection module 301) and/or context system(s) 124 (e.g., context analysis module 303 implementing a vision-language model (VLM)). Moreover, inference optimization module 306 may operate in coordination with object detection system 122 and/or context system(s) 124 by influencing how and when object detection system 122 and/or context system(s) 124 execute their respective AI/ML processes to reduce computational load, bandwidth usage, and power consumption while preserving compliance violation detection performance and/or context analysis performance. As described herein, inference optimization module 306 may perform such operations based on contextual factors including, but not limited to, frame selection outcomes, scene complexity, proximity to compliance-related objects, policy priorities, available computational resources, connectivity state, and latency constraints.

In some configurations, inference optimization module 306 may implement one or more pipeline-level optimization processes that control how visual data is selected, prepared, and processed by object detection system 122 and/or context system(s) 124, without modifying the underlying architecture or parameters of the AI/ML models themselves. Such pipeline-level optimization processes may be configured to reduce computational load, memory usage, bandwidth consumption, and power usage by dynamically adjusting execution behavior based on characteristics of the captured video data and/or image data, environmental context, and system state, while maintaining acceptable compliance-monitoring performance.

In some examples, the pipeline-level optimization processes may include determining whether high-resolution visual analysis is necessary based on characteristics of a compliance-related object and corresponding policy information and/or rule information. As described herein, inference optimization module 306 may obtain policy information and/or rule information from a policy/rule store (e.g., policy/rule store 208) that specifies importance, priority, criticality, and/or inspection requirements associated with different compliance-related object types or categories. Based on such policy information and/or rule information, inference optimization module 306 may dynamically adjust an input resolution of video data and/or image data provided to object detection system 122 and/or context system(s) 124.

In some cases, such resolution determination may occur prior to image or video capture. For example, edge device(s) 104 may be dispatched or instructed to capture a video or image(s) of a specific compliance-related object (e.g., a traffic control asset, accessibility feature, or public safety structure). Based on policy information and/or rule information indicating that the targeted compliance-related object is safety-critical, high-priority, or subject to heightened inspection requirements, inference optimization module 306 may instruct edge device(s) 104 to capture video data and/or image data at a higher resolution or with increased visual fidelity. Conversely, if the policy information and/or rule information indicates that the compliance-related object is lower priority or non-critical, inference optimization module 306 may instruct capture at a reduced resolution to conserve computational and power resources.

Additionally, or alternatively, resolution adjustment may be performed after image or video capture based on results of an initial object detection operation. In such configurations, object detection system 122 (e.g., object detection module 301) may first process captured video data and/or image data to identify or classify a compliance-related object present in the visual data. Based on the identified compliance-related object type, inference optimization module 306 may reference policy information and/or rule information to determine an associated importance level, criticality classification, and/or size-related threshold applicable to that object. The policy information and/or rule information may specify expected object dimensions, size categories, inspection priority levels, or resolution requirements for effective inspection of the object.

For example, object detection system 122 may identify a detected object as a traffic control sign based on video data and/or image data. Inference optimization module 306 may then obtain and process policy information and/or rule information indicating that traffic control signs are classified as safety-critical assets requiring higher inspection fidelity. Based on this importance or criticality classification, inference optimization module 306 may increase or preserve a higher resolution of the captured image data prior to further processing by context system(s) 124.

In another example, policy information may indicate that large compliance-related objects (e.g., bus shelters or traffic signage assemblies) may be sufficiently analyzed at lower resolutions, while smaller compliance-related objects (e.g., trash receptacles, drainage inlets, or curb ramps) require higher-resolution inputs to preserve inspection-relevant detail. Moreover, object detection system 122 may determine the presence and approximate size or bounding region of the compliance-related object, while inference optimization module 306 may evaluate whether the detected object size exceeds or falls below a size threshold defined in a policy and/or rule information associated with the detected compliance-related object. Based on this evaluation, inference optimization module 306 may downscale or upscale the resolution of the visual data prior to further processing by object detection system 122 and/or context system(s) 124.

In some aspects, the pipeline-level optimization processes may include implementing scene-aware throttling processes. The scene-aware throttling process may control a frequency at which object detection system 122 and/or context system(s) 124 are executed. Moreover, inference optimization module 306 may analyze characteristics of captured or selected frames, such as, but not limited to, motion intensity, scene complexity, and/or temporal redundancy, to determine whether full model inference is necessary for each frame.

For example, when a scene is largely static, includes minimal motion, or contains previously detected compliance-related objects that remain within view, inference optimization module 306 may reduce execution frequency or skip inference for selected frames while relying on tracking or previously generated results. Conversely, when inference optimization module 306 determines that a scene is complex, rapidly changing, or approaching a compliance-related object of interest (e.g., increased motion, multiple objects entering the field of view, or decreasing distance to a policy-identified asset), inference optimization module 306 may increase execution frequency, increase input resolution, or disable throttling to ensure timely and accurate detection.

In some instances, the pipeline-level optimization processes may leverage vehicle state information. In such instances, inference optimization module 306 may use the vehicle state information to influence how and when object detection system 122 and/or context system(s) 124 perform compliance violation detection processes and context analysis processes. The vehicle state information may enable object detection system 122 and/or context system(s) 124 to reduce memory usage, computational load, and inference complexity when performing such processes. As described herein, the vehicle state information may be obtained via a vehicle interface communicatively coupled to edge device(s) 104 (e.g., vehicle interface 205), including direct access to vehicle control systems such as a controller area network (CAN) bus or equivalent vehicle telemetry interface.

Examples of vehicle state information may include, without limitation, vehicle speed, yaw rate or turn rate, steering angle, brake state, gear selection, turn signal status, windshield wiper status, stability control flags, and service or tool state indicators (e.g., sweeper engaged or disengaged). Such vehicle state information may provide explicit signals regarding vehicle motion, orientation, maneuvering behavior, operational mode, and environmental conditions that would otherwise require inference from visual data alone.

In some examples, inference optimization module 306 may determine vehicle motion and vehicle intent based on vehicle state information of a vehicle associated with edge device(s) 104. Moreover, object detection system 122 and/or context system(s) 124 may use the vehicle motion and intent derived from vehicle state information to condition relevance, confidence, execution timing, and execution aggressiveness of compliance violation detection and context analysis processes. In some examples, the determined vehicle motion and intent may be used to disambiguate relevance of detected compliance-related objects.

For example, inference optimization module 306 may determine vehicle motion and intent based on steering angle, yaw rate, turn signal state, gear selection, and trajectory information. Moreover, object detection system 122 may use such determinations to evaluate whether a detected compliance-related object, such as a traffic sign, is operationally relevant to the vehicle's current path or task. For instance, a traffic sign detected while the vehicle is approaching straight ahead may be treated as contextually relevant and to be prioritized for downstream processing, such as higher-confidence context analysis, evidence generation, notification triggering, or resolution assessment workflows. In contrast, a traffic sign detected while the vehicle is turning away, reversing, parked, or signaling a turn may be deprioritized, flagged as contextually non-applicable, assigned a lower confidence score, buffered for later corroboration, or excluded from further processing altogether.

In some cases, the determined vehicle motion and intent may be used to assess observation quality and confidence associated with detected compliance-related objects. For example, inference optimization module 306 may evaluate vehicle state information such as vehicle speed, yaw rate, steering activity, braking events, and stability control flags to determine whether visual data captured by edge device(s) 104 corresponds to a stable and reliable observation. Moreover, object detection system 122 may use such determinations to condition confidence scoring, downstream processing priority, or evidentiary treatment of detected compliance-related objects. As described herein, the confidence scoring may indicate a degree of reliability, evidentiary sufficiency, or trustworthiness of a detected condition for purposes of enforcement, notification, resolution assessment, or archival, rather than merely reflecting model classification probability. Further, the confidence scoring may be used to influence whether and how the detected condition is acted upon by downstream enforcement, notification, or resolution processes.

For instance, video data and/or image data captured by edge device 104 while the vehicle is traveling steadily, aligned with the object of interest, and exhibiting low yaw or minimal maneuvering may be treated as higher-confidence evidence. Such higher-confidence detections may be prioritized for downstream context analysis, included in evidence packages, used to trigger notifications or escalation workflows, or relied upon for resolution assessment and compliance reporting. In contrast, video data and/or image data captured by edge device 104 during sharp turns, emergency braking, high yaw rates, or unstable vehicle motion may be assigned reduced confidence, flagged as potentially degraded, or marked as requiring corroboration. In such cases, downstream processes may buffer the detection for additional confirmation, deprioritize notification or enforcement actions, annotate the detection as low-confidence context, or exclude the detection from evidentiary use.

In some aspects, the determined vehicle motion and intent may be used to distinguish between different operational modes associated with visual observations, such as drive-by observation versus deliberate inspection. For example, inference optimization module 306 may determine vehicle motion and intent based on vehicle speed, brake state, gear selection, and duration of vehicle stationary periods. Moreover, object detection system 122 and/or context system(s) 124 may use such determinations to classify whether video data and/or image data was captured during an intentional inspection maneuver or during transient pass-through operation.

For instance, video data and/or image data captured by edge device 104 while the vehicle is parked or stopped at a curb, with braking engaged and minimal motion, may be treated as drive-by observation state evidence and prioritized for high-confidence context analysis, evidence generation, resolution tracking, or enforcement workflows. In contrast, video data and/or image data captured while the vehicle is moving through an area at speed without stopping may be treated as drive-by observation and may be deprioritized, buffered for corroboration, or flagged as requiring follow-up verification.

In some instances, the determined vehicle motion and intent may be used to selectively control inference aggressiveness and execution timing of object detection system 122 and/or context system(s) 124. For instance, inference optimization module 306 may evaluate vehicle motion stability, maneuver intensity, and environmental indicators derived from vehicle state information to determine whether conditions are favorable for high-fidelity visual analysis. Moreover, based on such determinations, object detection system 122 and/or context system(s) 124 may adjust how their AI/ML processes are executed without modifying underlying model architectures or trained parameters, including modifying sampling frequency, input resolution, model execution frequency, or scope of context analysis.

For example, when vehicle motion and intent indicate stable forward movement, low yaw, minimal steering correction, and steady speed, inference optimization module 306 may permit full or increased inference execution by object detection system 122 and/or context system(s) 124, including higher sampling frequency, higher input resolution, execution of additional compliance violation detection processes, and/or execution of more detailed context analysis processes. Conversely, when vehicle motion and intent indicate unstable or uninformative conditions, such as sharp turns, emergency braking, high yaw rates, reversing, or degraded visibility, inference optimization module 306 may cause object detection system 122 and/or context system(s) 124 to throttle inference execution, skip selected frames, down-weight detections, reduce context analysis depth, or defer processing until conditions improve.

In some configurations, inference optimization module 306 may implement one or more model-level optimization processes that modify or select one or more AI/ML models or encoders executed by object detection system 122 and/or context system(s) 124. Such model-level optimization processes may include pruning, model substitution, or selection of reduced-capacity model variants to decrease parameter count, memory footprint, and inference latency while maintaining acceptable compliance-monitoring performance.

In some examples, the one or more model-level optimization processes may include pruning. Pruning may include removing or disabling portions of a vision model or encoder and/or a text model or encoder, such as unnecessary layers, channels, attention heads, or feature maps, using standard pruning techniques or toolkits. By reducing model complexity, pruning may enable faster inference and lower resource usage at the cost of reduced representational capacity, particularly when combined with policy-driven prioritization and downstream cloud-side analysis, as described herein.

In some cases, the one or more model-level optimization processes may include one or more quantization processes. The quantization processes may reduce computational complexity, memory usage, and power consumption associated with execution of AI/ML models by object detection system 122 and/or context system(s) 124. Moreover, the quantization processes may compress model parameters, activations, and/or embeddings to operate at reduced numerical precision, such as FP16, INT8, or lower, while preserving sufficient accuracy for compliance-related detection and classification tasks. As described herein, inference optimization module 306 may apply the quantization processes to one or more components of the AI/ML pipeline, including, without limitation, vision encoders, object detection models, text encoders, multimodal fusion layers, or classifier heads. For example, a vision encoder of object detection system 122 or a vision encoder 354 of a VLM may generate reduced-precision visual embeddings (e.g., INT8 embeddings), while a text encoder 358 may generate reduced-precision text embeddings (e.g., FP16 embeddings). The compressed embeddings may be processed by downstream components with reduced memory bandwidth and faster execution.

In some aspects, the quantization processes may be associated with quantization-aware training (QAT) (hereinafter “QAT” processes). As described herein, QAT processes may include training or fine-tuning AI/ML models while explicitly modeling the effects of reduced-precision arithmetic, such that the trained models are robust to quantization-induced noise during inference. In some instances, inference optimization module 306 may coordinate QAT processes in conjunction with training module 304 and training framework 350 illustrated in FIG. 3B.

For instance, during domain-specific training of a VLM using training framework 350, vision encoder 354 and text encoder 358 may be trained or fine-tuned to generate embeddings that remain semantically meaningful when represented at reduced precision. Such training may ensure compatibility with compressed visual embeddings generated from small image crops stored in image bank 352 and compressed text embeddings derived from short, templated prompts stored in domain-specific prompt bank 356.

In some examples, the QAT processes may be performed in a domain-constrained manner, in which the semantic space of the VLM is intentionally restricted to domain-relevant concepts defined by policy information and/or rule information. Rather than optimizing the VLM to perform general-purpose visual-language reasoning, QAT processes may focus on preserving accuracy for a limited vocabulary of compliance-related object types, condition descriptors, and contextual modifiers relevant to a particular operational domain, such as municipal compliance monitoring or other regulated or policy-driven inspection domains.

For example, and as illustrated with FIG. 3B, for a municipal compliance domain or other regulated or policy-driven inspection domains, training module 304 may fine-tune the VLM using a restricted set of prompts corresponding to policy-defined conditions such as “overflowing trash bin,” “obstructed traffic sign,” “faded crosswalk,” or “sand accumulation near curb.” By collapsing the semantic space to policy-relevant distinctions, the VLM may tolerate more aggressive quantization while still producing coarse but actionable classifications suitable for enforcement or inspection workflows.

In some cases, the quantization-aware training (QAT) processes may incorporate policy-aware quantization sensitivity derived from policy information and/or rule information stored in a policy/rule store (e.g., policy/rule store 208). In such configurations, inference optimization module 306 may use the policy information and/or rule information to determine policy-defined priorities or criticality levels associated with different compliance-related objects or violation categories. Moreover, inference optimization module 306 adjust the aggressiveness of quantization applied to different portions of a model, including precision levels of generated embeddings based on the determined policy-defined priorities or criticality levels associated with different compliance-related objects or violation categories.

For example, embeddings associated with higher-criticality compliance-related objects, such as traffic control signs, pedestrian crosswalks, or school-zone infrastructure, may be preserved at higher effective precision (e.g., less aggressive quantization or higher-bit representations) to maintain classification reliability and enforcement confidence. Conversely, embeddings associated with lower-criticality compliance-related objects, such as minor graffiti or cosmetic surface damage, may be represented using more aggressively quantized embeddings (e.g., lower-bit representations) to reduce computational load and memory usage while maintaining sufficient accuracy for coarse but actionable classification.

In some aspects, QAT processes may be used to evaluate and characterize execution suitability of different portions or submodules of a vision-language model (VLM) or other AI/ML models for deployment on edge device(s) 104 versus cloud server(s) 120. For example, inference optimization module 306 may apply QAT to multiple submodules of a VLM, such as a vision encoder (e.g., vision encoder 354), multimodal fusion layers, classifier heads, or language-based reasoning components, and may evaluate performance characteristics of each submodule under reduced-precision representations (e.g., INT8, FP16). Based on such evaluation, inference optimization module 306 may determine which submodules maintain acceptable task fidelity, stability, and confidence under quantization and as a result suitable for execution on resource-constrained edge devices 104, and which submodules exhibit higher sensitivity to quantization noise and are accordingly better suited for execution on cloud server(s) 120 where higher-precision computation is available.

In some instances, inference optimization module 306 may generate and maintain execution-partitioning data based on results of the QAT processes, where the execution-partitioning data identifies, for each evaluated submodule, whether the submodule is designated as edge-suitable, cloud-preferred, or conditionally deployable based on contextual factors. For example, inference optimization module 306 may determine that a vision encoder used for coarse region-of-interest (ROI) detection, object presence determination, or binary context classification maintains high task fidelity under aggressive quantization and is therefore well suited for execution on edge device(s) 104, where computational resources, power budgets, and latency constraints are limited. Conversely, inference optimization module 306 may determine that detailed semantic classifiers, fine-grained object localization heads, or language-based reasoning components that perform higher-order contextual inference exhibit greater degradation under quantization and are therefore designated for execution on cloud server(s) 120, where higher-precision computation (e.g., FP16 or FP32), greater memory availability, and relaxed latency constraints are available. The execution-partitioning data may be stored, updated over time, and referenced during runtime inference.

In some examples, inference optimization module 306 may dynamically reference the execution-partitioning data to adjust execution boundaries between edge device(s) 104 and cloud server(s) 120 based on contextual factors such as network connectivity state, available bandwidth, energy constraints, system load, or policy priorities. For example, during periods of limited or degraded network connectivity, inference optimization module 306 may prioritize execution of submodules designated as edge-suitable while deferring, buffering, or scheduling execution of cloud-designated submodules for later processing when connectivity is restored. Conversely, when network connectivity and cloud resources are available, inference optimization module 306 may enable execution of higher-fidelity cloud-designated submodules to perform deeper semantic analysis, fine-grained classification, or extended reasoning.

In some configurations, inference optimization module 306 elect among multiple available model variants rather than modifying a single model architecture. In such configurations, inference optimization module 306 may determine, based on contextual factors such as policy priorities, scene complexity, available computational resources, or latency constraints, which model variant is to be executed by object detection system 122 and/or context system(s) 124. For example, based on the contextual factors, inference optimization module 306 may cause object detection system 122 to execute a selected lightweight detector model including, but not limited to, EfficientNet-Lite-based detectors, MobileNetV3-based detectors, SSD-Lite, YOLO-Lite, or other compact detection architectures suitable for resource-constrained environments. Similarly, based on the contextual factors, inference optimization module 306 may cause context system(s) 124 to execute a selected lightweight vision-language model (VLM), such as MiniCLIP, MobileCLIP, Tiny-ViT-based multimodal models, or distilled variants of BLIP or SigLIP, that are capable of producing interpretable and semantically meaningful outputs with reduced computational overhead.

In some cases, the AI/ML model(s) described herein may be implemented within a multi-head neural network architecture comprising multiple interconnected neural networks, each optimized for distinct compliance violation detection and context analysis tasks. For example, as illustrated in FIG. 3C, compliance violation detection and analysis model 390 may represent a more detailed implementation of portions of the AI/ML model and/or training framework described with respect to FIG. 3B. For example, the video data and/or generative-AI-derived frames processed in FIG. 3C may correspond to image data retrieved from image bank 352 of FIG. 3B. Moreover, asset of interest multi-head neural network 392 and context multi-head neural network 394 may represent a more specific implementations of processes related to vision encoder 354 FIG. 3B, such as an autoencoder or feature extraction network comprising multiple heads configured to extract compliance-related objects and corresponding contextual attributes associated with the compliance-related objects. For example, as illustrated in FIG. 3C, compliance violation detection and analysis model 390 may include a first multi-head neural network or asset of interest multi-head neural network 392, a second multi-head neural network or context multi-head neural network 394, and in some instances, a third multi-head neural network or compliance checking decision network 396.

As described herein, asset of interest multi-head neural network 392 may detect objects or objects of interest, environmental conditions and/or other visual indicators that may be captured in the sensor data, such as video data (e.g., video frames) and/or image data captured by edge device 104 (e.g., sensor system 202). Moreover, asset of interest multi-head neural network 392 may extract features related to the detected compliance-related objects, environmental conditions and/or other visual indicators. In some configurations, the multi-head architecture may comprise a convolutional neural network (CNN)-based architecture with multiple detection heads configured to extract different aspects of visual and contextual information. In some examples, the multi-head architecture may comprise a transformer-based architecture (e.g., a Vision Transformer) in which image tokens are embedded and processed using multiple attention heads to extract distinct feature representations corresponding to compliance-related objects and associated contextual characteristics. In some instances, asset of interest multi-head neural network 392 may include multiple detection heads. Each detection head may be optimized for different object classes, such as classes associated with compliance-related objects (e.g., small-scale infrastructure elements). Moreover, each detection head may generate data identifying and characterizing each detected object and/or corresponding extracted feature(s).

Context multi-head neural network 394 may determine the environmental context, situational context or context factors (e.g., population density (via a corresponding AI/ML model, such as a person detection model), traffic density (via a corresponding AI/ML model, such as a vehicle detection and tracking model), building density and urbanization levels (via a corresponding AI/ML model, such as a landmark recognition or building detection model), weather conditions (via feature-based image processing and external metadata sources), lighting conditions (via feature-based image processing and external metadata sources), seasonal conditions (via feature-based image processing and external metadata sources), etc.) associated with detected objects or objects of interest, environmental conditions, and/or other visual indicators) based on corresponding context information (e.g., genAI frames).

In some configurations, each detection head of context multi-head neural network 394 may generate context-aware feature embeddings characterizing distinct contextual dimensions. The context-aware feature embeddings determined or generated by context multi-head neural network 394 may be used by downstream components (e.g., compliance checking decision network 396) to determine whether a compliance violation has occurred and, in some instances, to determine context information associated with a detected compliance violation. In some instances, the context multi-head neural network 394 and/or compliance checking decision network 396 may determine a condition associated with a compliance-related object based on one or more determined context factors. The determined condition may reflect, for example, an assessed state, status, or operational impact of the compliance-related object under the identified environmental context or situational context. The compliance checking decision network 396 may detect the compliance violation based at least in part on the determined condition in combination with visual features extracted from the sensor data. Moreover, each detection head may generate data identifying and characterizing each determined context factor (e.g., context-aware feature embeddings).

Compliance checking decision network 396 may correspond to similarity/fusion module 360 and/or classifier head 362 of FIG. 3B. Moreover, compliance checking decision network 396 may determine whether a compliance violation has occurred based on the features extracted from asset of interest multi-head neural network 392 and the context factors determined by the context multi-head neural network 394. In some cases, compliance checking decision network 396 may not be a multi-head neural network (e.g., one or more neural networks). In instances where a compliance violation is detected (e.g., missing traffic sign, obstructed pedestrian walkway, overflowing trash receptacle), compliance checking decision network 396 may generate a notification, such as notification 398 that includes one or more portions of the sensor data associated with the detected compliance violation (e.g., portion(s) of video data and/or image data associated with objects or objects of interest indicative of a compliance violation), and associated context information. In some cases, the notifications may further include timestamps associated with the detected compliance violation and/or location information associated with the detected compliance violation (e.g., GPS coordinates).

As illustrated in FIG. 3C, the multiple multi-head neural network architecture may include feedback mechanisms that enable the multiple multi-head neural network architecture to improve compliance detection accuracy. For instance, the extracted compliance-related object feature(s), determined context factors or context-aware feature embeddings, and/or detected compliance violation(s), may be reused, refined or reanalyzed to improve the detection accuracy across the layered architecture. In some instances, the data or information included in the notifications may be used to retrain the AI/ML model(s) including one or more of asset of interest multi-head neural network 392, context multi-head neural network 394, and/or compliance checking decision network 396.

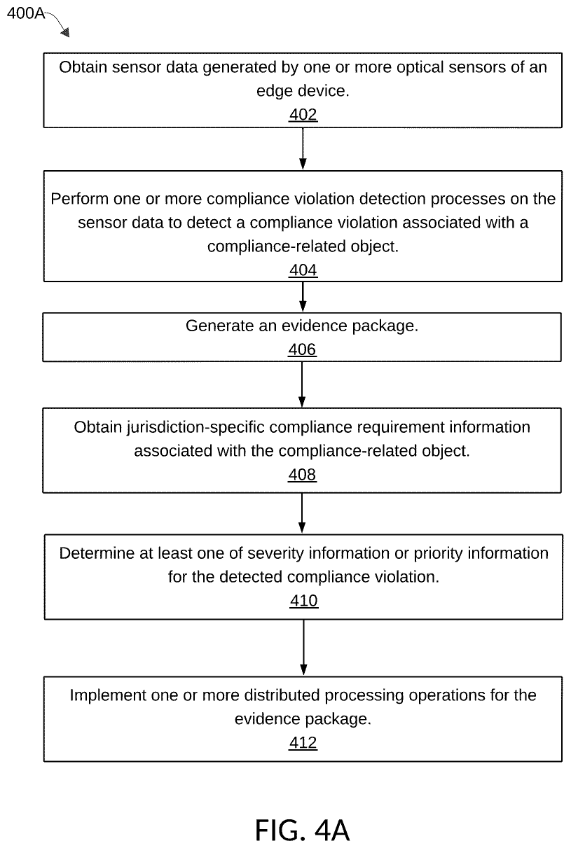

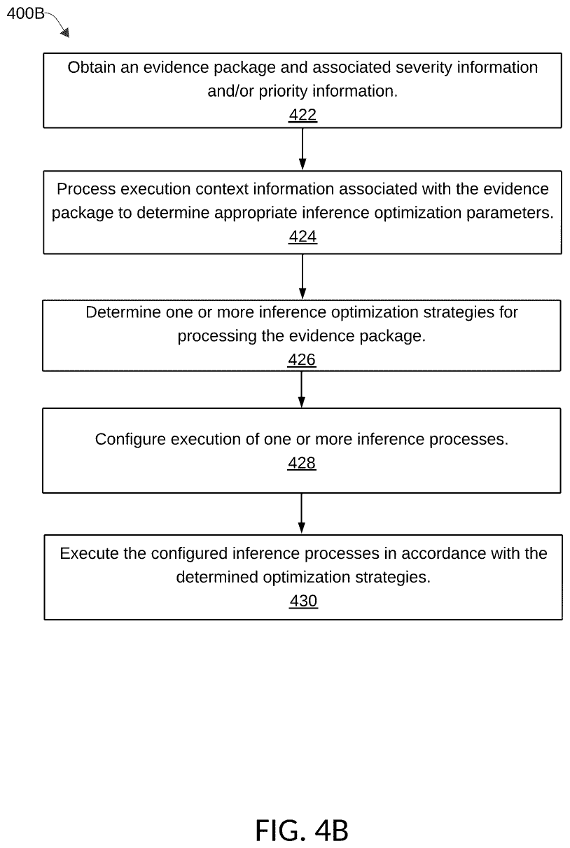

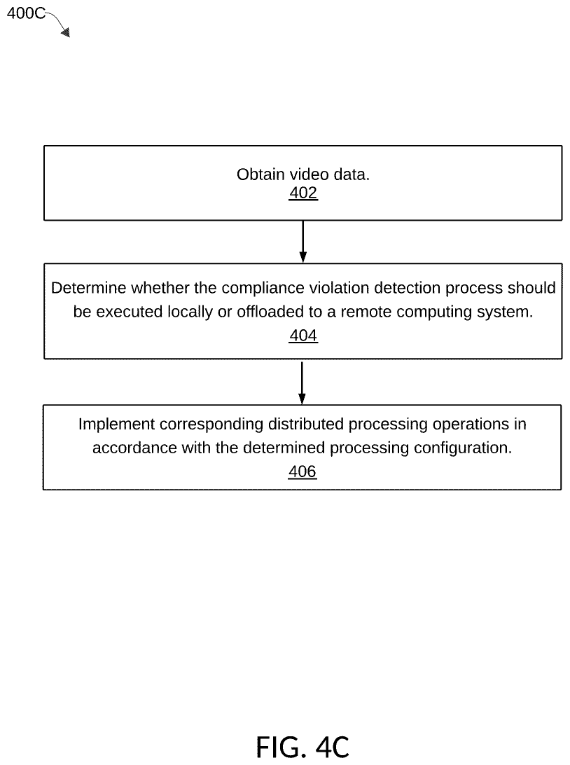

FIG. 4A is a flowchart for a method 400A for implementing distributed processing operations for compliance monitoring, according to some examples of the present disclosure. Method 400A can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4A, as will be understood by a person of ordinary skill in the art.

Method 400A shall be described with reference to FIGS. 1-3A, 3B and/or 3C. However, method 400A is not limited to those examples. In step 402, an edge device (e.g., edge device 104) may obtain sensor data generated by one or more optical sensors of the edge device. As described herein, the sensor data may include video data and/or image data captured as the edge device operates within a local jurisdiction or monitored environment. For example, an edge device mounted on a municipal vehicle may capture video data while the vehicle travels along a roadway within a school zone.

In step 404, the edge device may perform one or more compliance violation detection processes on the sensor data to detect a compliance violation associated with a compliance-related object. As described herein, the compliance violation detection processes may be implemented by an object detection system (e.g., object detection system 122). For example, the object detection system may analyze video frames to detect a traffic control sign and determine that the sign is tilted, damaged, or fallen over, indicating a potential compliance violation associated with traffic control infrastructure.

In step 406, based on detection of the compliance violation, the edge device may generate an evidence package. As described herein, the evidence package may comprise at least a portion of the sensor data associated with the detected compliance violation. For example, the evidence package may include one or more video frames or image crops depicting the fallen stop sign, together with associated metadata such as a timestamp, location information, and an identifier for the detected compliance-related object.

In step 408, the edge device may obtain jurisdiction-specific compliance requirement information associated with the compliance-related object. As described herein, the jurisdiction-specific compliance requirement information may include at least one of rule information or policy information applicable to the local jurisdiction. In some examples, the jurisdiction-specific compliance requirement information may be obtained by an upload module of the edge device (e.g., upload module 212) from a policy/rule store (e.g., policy/rule store 208), as illustrated in FIG. 3A. For example, the edge device may access policy information indicating that traffic control signs located within school zones are classified as safety-critical assets and are subject to heightened inspection and reporting requirements.

In some instances, upload module 212 may determine the appropriate jurisdiction-specific compliance requirement information by correlating identifying attributes of the detected compliance-related object with entries in the policy/rule store. Such identifying attributes may include, without limitation, an object type or classification determined by the compliance violation detection process (e.g., traffic control sign, waste receptacle, accessibility feature), location information associated with the detected object (e.g., school zone, intersection, residential area), and, in some instances, contextual attributes determined by context analysis processes. Based on such correlation, upload module 212 may select rule information or policy information defining asset criticality classifications, inspection requirements, response time thresholds, reporting obligations, or enforcement handling preferences applicable to the detected compliance-related object within the local jurisdiction.

In step 410, the edge device may determine at least one of severity information or priority information for the detected compliance violation based on the jurisdiction-specific compliance requirement information. As described herein, the severity information may characterize a seriousness or potential safety impact associated with the detected compliance violation, while the priority information may characterize an urgency or handling order. In some examples, such determinations may be performed by a severity engine of the edge device (e.g., severity engine 308 of upload module 212), as illustrated in FIG. 3A.

For example, based on the policy information identifying the fallen stop sign as a safety-critical violation occurring in a school zone, the edge device may assign elevated severity information and a high priority level to the evidence package. In contrast, a detected compliance violation associated with a lower-criticality condition, such as cosmetic graffiti on a non-safety-related structure, minor surface discoloration, or non-obstructive debris located outside a designated safety zone, may be assigned a lower severity level or priority level, indicating reduced urgency, deferred handling, or eligibility for batch processing within the distributed processing architecture.

In step 412, the edge device may implement one or more distributed processing operations for the evidence package based on the determined severity information and/or priority information. As illustrated in FIG. 3A, an upload module of the edge device (e.g., upload module 212), including one or more subcomponents such as a severity engine (e.g., severity engine 308) and an upload controller (e.g., upload controller 310) may determine and/or implement the distributed processing operation(s) for the evidence package based on the determined severity information and/or priority information. For example, severity engine 308 may provide the determined severity information and/or priority information to upload controller 310. Based on the severity information and/or priority information, upload controller 310 may select, schedule, and execute one or more distributed processing operations that define how the evidence package and any associated context data are processed, prioritized, transmitted, or stored within the distributed processing architecture.

In some examples, implementing the distributed processing operations may include selectively transmitting the evidence package, or one or more portions thereof, to a remote computing system (e.g., cloud server(s) 120), triggering additional context analysis processes, prioritizing the evidence package relative to other detected compliance events, or combinations thereof. For example, evidence packages associated with higher severity levels or higher priority levels, such as safety-critical compliance violations involving traffic control infrastructure, accessibility features, or public safety assets, may be selected for expedited handling and transmitted ahead of other pending evidence packages. In such examples, upload controller 310 may cause the evidence package and associated context data to be transmitted immediately or with elevated priority to cloud server(s) 120 for additional context analysis, validation, escalation, or reporting. Moreover, the distributed processing operations may include triggering generation of one or more notifications to relevant recipients, such as a municipal agency responsible for traffic safety, accessibility enforcement, or infrastructure maintenance, based on the nature and severity of the detected compliance violation.

In contrast, for evidence packages associated with lower severity levels or lower priority levels, such as cosmetic degradation, minor cleanliness issues, or conditions not posing an immediate safety risk, upload controller 310 may determine that processing is to be performed locally at the edge device, deferred for later transmission, aggregated with other evidence packages, or transmitted to cloud server(s) 120 according to scheduling policies, batching thresholds, or available network resources. In some instances, such lower-severity evidence packages may be stored locally as candidate evidence for trend analysis, monitoring, or later escalation if corroborated by additional detections.

In some configurations, upload controller 310 may further consider operational state information of the edge device, including available bandwidth, connectivity quality, computational workload, power state, or latency constraints, when implementing the distributed processing operations. In this manner, upload module 212 coordinates severity-aware, priority-aware, and resource-aware execution of distributed processing operations for evidence packages within the compliance monitoring architecture.

FIG. 4B is a flowchart for a method 400B for optimizing inference execution and execution control within a distributed compliance monitoring architecture, according to some examples of the present disclosure. Method 400B can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4B, as will be understood by a person of ordinary skill in the art.

Method 400B shall be described with reference to FIGS. 1-3A, 3B and/or 3C. However, method 400B is not limited to those examples. In step 422, an edge device (e.g., edge device 104) may obtain an evidence package and associated severity information and/or priority information determined as part of distributed processing operations, as described with respect to FIG. 4A. For example, the evidence package may correspond to a detected compliance violation involving a fallen stop sign located within a designated school zone. Moreover, the evidence package may include video frames depicting the fallen sign together with location information, timestamps, and an assigned high priority level.

In step 424, the edge device may process execution context information associated with the evidence package to determine appropriate inference optimization parameters. As described herein, the execution context information may include, without limitation, the determined severity information or priority information, current computational workload metrics of the edge device, vehicle state information (e.g., whether the vehicle is stationary or in motion), connectivity quality, latency constraints, and applicable jurisdiction-specific compliance requirements. In some examples, such evaluation may be coordinated by upload module 212 in conjunction with severity engine 308 and upload controller 310, as illustrated in FIG. 3A.

In step 426, based on the evaluated execution context information, the edge device may determine one or more inference optimization strategies for processing the evidence package. As described herein, the inference optimization strategies may define how compliance violation detection processes, context analysis processes, or related AI/ML inference operations are executed. For example, for a high-priority compliance violation involving a fallen stop sign in a school zone, the edge device may select higher-fidelity inference settings, such as higher input resolution, reduced frame skipping, execution of additional object classification or validation models, or escalation of context analysis to a remote computing system. In contrast, for lower-priority compliance violations, such as minor graffiti on a non-safety-related structure, the edge device may select reduced-resolution processing, lightweight inference models, deferred execution, or local-only analysis.

In step 428, the edge device may configure execution of one or more inference processes based on the determined inference optimization strategies. As described herein, such configuration may include enabling or disabling specific AI/ML models, adjusting inference frequency, selecting between edge-based and cloud-based execution paths, or modifying execution parameters associated with object detection module 301 and/or context analysis module 303. In some examples, upload controller 310 may apply policy-driven execution controls that map severity or priority levels to predefined inference execution profiles.

In step 430, the edge device may execute the configured inference processes in accordance with the determined optimization strategies. For example, in response to a high-priority fallen stop sign detected within a school zone, the edge device may perform initial object detection locally to confirm the violation, while triggering enhanced context analysis or additional validation processing at a remote computing system to generate detailed context data and language-based summaries. In contrast, for lower-priority compliance violations, inference execution may be limited to local confirmation and aggregation without immediate escalation.

In some configurations, the edge device may monitor execution outcomes and system conditions to dynamically adjust inference optimization strategies over time. As described herein, the edge device may update execution parameters based on factors such as persistence of the compliance violation across multiple detections, corroboration by additional vehicles or edge devices, changes in vehicle state, or updated policy or rule information. In some instances, evidence packages initially processed under lower-priority inference settings may be promoted for higher-fidelity processing or cloud-based execution if subsequent detections increase confidence, severity, or priority associated with the compliance violation.

FIG. 4C is a flowchart for a method 400C for determining distributed processing configurations prior to performing substantive compliance violation detection or context analysis, according to some examples of the present disclosure. Method 400C can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4C, as will be understood by a person of ordinary skill in the art.

Method 400C shall be described with reference to FIGS. 1-3A, 3B and/or 3C. However, method 400C is not limited to those examples. At step 432, an edge device (e.g., edge device(s) 104) obtains video data using one or more optical sensors included in a sensor system (e.g., sensor system 202). The edge device may be installed on a vehicle, robots, drones, stationary monitoring station, or any infrastructure asset that captures real-time images and video of a monitored jurisdiction. The video data may include images of public infrastructure, roadways, municipal assets, or areas subject to compliance regulations. For example, an edge device mounted on a municipal inspection vehicle may capture video data while traveling through a residential neighborhood containing waste receptacles subject to municipal placement and overflow regulations. In some instances, the acquired video data is stored temporarily in storage/buffers of the edge device(e.g., storage/buffers 206) before being processed.

At step 434, prior to performing substantive compliance violation detection or context analysis, the edge device may determine whether the compliance violation detection process should be executed locally or offloaded to a remote computing system (e.g., a cloud server 120). In some examples, the edge device may evaluate or determine one or more processing thresholds to determine how subsequent processing is to be distributed within the compliance monitoring environment. As described herein, such evaluation may be performed by processing system 204 in coordination with upload module 212, and may be based on factors including, without limitation, computational workload metrics, memory availability, power state, connectivity conditions, latency constraints, and characteristics of the sensor data.

In some examples, the edge device may determine that a compliance violation detection process associated with the sensor data does not exceed a predefined processing threshold, indicating that initial compliance violation detection may be performed locally at the edge device. In such examples, the edge device may further determine whether a context analysis process associated with the same sensor data exceeds a predefined processing threshold, thereby indicating whether context analysis should be executed locally or deferred to a remote computing system.

In some cases, the edge device may determine that both the compliance violation detection process and the context analysis process do not exceed respective predefined processing thresholds, indicating that both processes may be executed locally. In some aspects, the edge device may determine that one or more processing thresholds are exceeded due to factors such as high video resolution, adverse lighting conditions, complex scenes, or constrained edge resources, indicating that one or more processing stages should be offloaded or deferred.

In step 406, based on the threshold-based determinations, the edge device may implement corresponding distributed processing operations in accordance with the determined processing configuration. As described herein, implementing the distributed processing operations may include, without limitation, selectively executing compliance violation detection locally on the edge device, selectively executing context analysis locally on the edge device, transmitting an evidence package to a remote computing system for further processing, or combinations thereof.

For example, where the edge device determines that compliance violation detection does not exceed a processing threshold but context analysis does exceed a processing threshold, the edge device may execute the compliance violation detection process locally to detect an overflowing waste receptacle, generate an evidence package including video frames depicting the overflow condition, and transmit the evidence package to a cloud server (e.g., cloud server(s) 120) for execution of the context analysis process. In such example, the cloud server may determine contextual attributes such as severity, persistence, or proximity to regulated locations based on the received evidence package.

In another example, where the edge device determines that neither the compliance violation detection process nor the context analysis process exceeds the predefined processing thresholds, the edge device may execute both processes locally, generate context data including context information and associated content, and transmit the resulting context data to the cloud server for notification generation, aggregation, or reporting.

### Example Neural Network Architectures

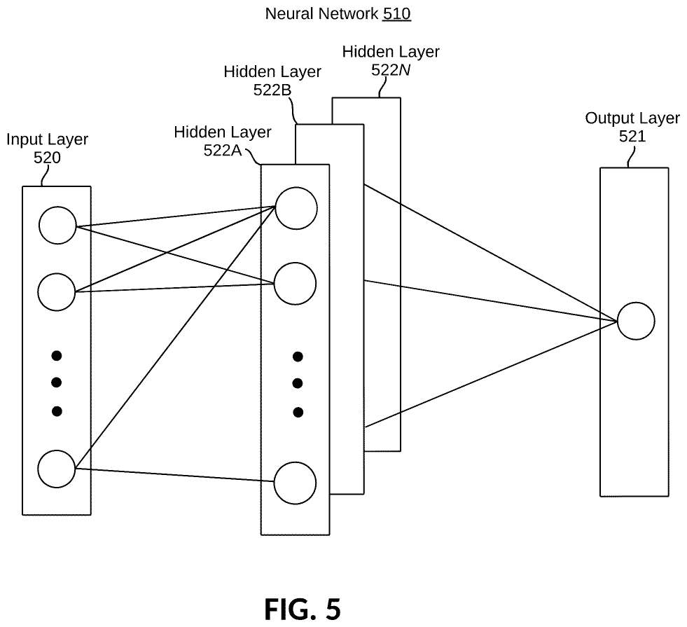

FIG. 5 is a diagram illustrating an example architecture 500 of an example neural network 510. The example architecture 500 can be used to implement any neural network described herein and/or any components described herein that can include or implement a neural network. For example, the architecture 500 can be used to implement a neural network(s) of the object detection system 122, context analysis system(s) 124, feedback engine 502 and/or any portion thereof.

The architecture 500 of the neural network 510 can include an input layer 520 that can be configured to receive and process data to generate one or more outputs. The architecture 500 of the neural network 510 can also include hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. The architecture 500 of the neural network 510 can further include an output layer 521 that provides an output resulting from the processing performed by the hidden layers 522a, 522b, through 522n.

The neural network 510 is a multi-layer neural network of interconnected nodes. Each node can represent a piece of information. Information associated with the nodes is shared among the different layers and each layer retains information as information is processed. In some cases, the neural network 510 can include a feed-forward network, in which case there are no feedback connections where outputs of the network are fed back into itself. In some cases, the neural network 510 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 510 are shown as having multiple output lines, a node can have a single output and all lines shown as being output from a node represent the same output value.

In some cases, each node or interconnection between nodes can have a weight that is a set of parameters derived from the training of the neural network 510. Once the neural network 510 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network 510 to be adaptive to inputs and able to learn as more and more data is processed.

The neural network 510 is pre-trained to process the features from the data in the input layer 520 using the different hidden layers 522a, 522b, through 522n to provide the output through the output layer 521.

In some cases, the neural network 510 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 510 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 510 can perform a backward pass by determining which inputs (weights) most contributed to the loss of the network and can adjust the weights so that the loss decreases and is eventually minimized.

The neural network 510 can include any suitable deep network. One example neural network includes a transformer network, which can be used to implement a large language model. Another example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 510 can include any other deep network other than a transformer or CNN, such as an encoder-decoder network, an encoder-only network, a decoder-only network, a mixture of experts (MoE) network, a generative model network, an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc. Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

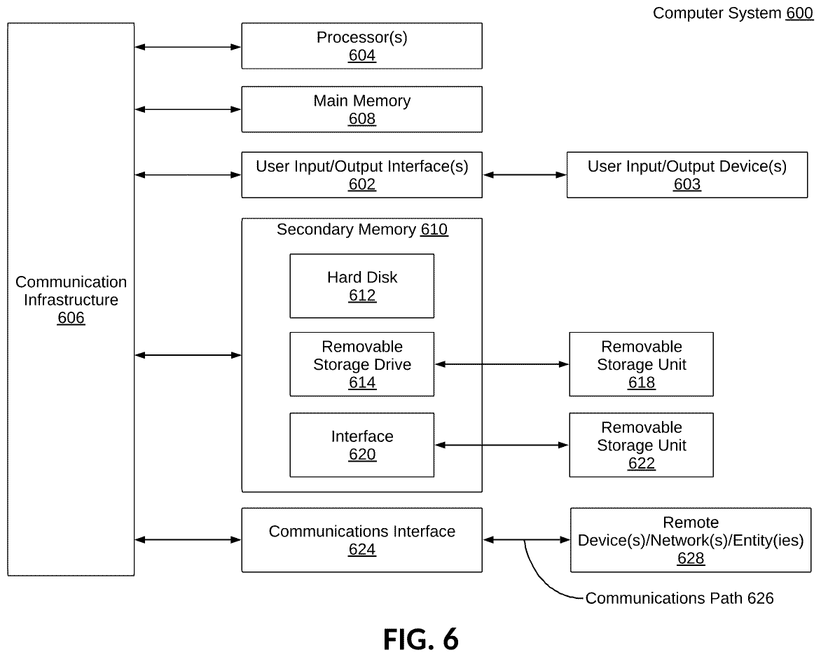

Various aspects and examples may be implemented, for example, using one or more well-known computer systems, such as computer system 600 shown in FIG. 6. For example, edge device 104 may be implemented using combinations or sub-combinations of computer system 600. Also, or alternatively, one or more computer systems 600 may be used, for example, to implement any of the aspects and examples discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random-access memory (RAM). Main memory 608 may include one or more levels of cache. Main memory 608 may have stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

As used herein, examples of public and/or private infrastructure can include, but are not limited to, transportation infrastructure (e.g., roadways, highways, intersections, bridges, tunnels, sidewalks, crosswalks, bike lanes, pedestrian pathways, transit stations, etc.), public utility infrastructure (e.g., streetlights, traffic signals, power lines, water treatment facilities, drainage systems, fire hydrants, public communication networks, etc.), waste management infrastructure (e.g., trash collection sites, recycling centers, public waste bins, hazardous waste disposal stations, sanitation systems, etc.), municipal and government facilities (e.g., city halls, courthouses, public libraries, police stations, fire stations, post offices, administrative buildings, etc.), recreational and public spaces (e.g., parks, playgrounds, sports fields, plazas, public squares, waterfronts, green spaces, etc.), commercial and industrial zones (e.g., shopping centers, markets, industrial complexes, warehouses, designated business districts, etc.), residential areas (e.g., apartment complexes, housing developments, gated communities, and urban residential districts, etc.), public transit infrastructure (e.g., bus stops, train stations, ferry terminals, airport facilities, etc.), and environmental and conservation areas (e.g., protected wildlife areas, nature reserves, floodplains, stormwater management zones, etc.).

Additionally, examples of regulatory and infrastructure-related requirements can include, but are not limited to, road infrastructure and assets related requirements (e.g., requirements related to the maintenance, repair, and condition of roads, highways, intersections (e.g., acceptable thresholds for road surface conditions, pothole repair response times, and structural integrity of roadways), and associated traffic control devices (e.g., traffic signals, stop signs, and pedestrian crossings), public transportation and commuter facility related requirements (e.g., requirements related to the operation and maintenance of public transit infrastructure, including bus stops, shelters, bike lanes, pedestrian walkways, and transit hubs, such as the cleanliness standards, structural maintenance protocols, and accessibility compliance to accommodate individuals with disabilities), public utility and lighting systems related requirements (e.g., requirements related to the operation, maintenance, and serviceability of public lighting infrastructure, including streetlights, lamp posts, and other municipal illumination systems (e.g., operational performance standards, outage response times, and safety-related lighting levels for pedestrian and vehicular areas)), waste management and sanitation related requirements (e.g., requirements related to concerning the placement, condition, and maintenance of public waste receptacles (e.g., trash cans, recycling bins, hazardous waste disposal sites), as well as compliance with municipal waste collection and recycling program), and aesthetic and environmental related requirements (e.g., requirements related to the visual appeal, structural integrity, and cleanliness of public spaces, including parks, landscaping, historical landmarks, public monuments, and urban beautification initiatives, such as requirements related to graffiti removal mandates, landscape maintenance guidelines, and policies restricting unauthorized modifications to public property).

Examples of safety-related requirements include, but are not limited to, road hazard management requirements (e.g., requirements related to the detection, reporting, and resolution of road hazards, including potholes, roadway obstructions, collapsed sidewalks, missing or damaged road signage, and malfunctioning traffic signals), waste accumulation and waste management compliance (e.g., requirements related to the timely removal of accumulated waste, illegal dumping sites, improperly managed construction debris, acceptable waste storage periods, prohibited waste disposal practices, and remediation procedures for unauthorized waste accumulation), debris and hazardous material management related requirements (e.g., requirements related to the monitoring, reporting, and addressing hazardous materials, fallen tree limbs, road debris, or other safety hazards that may obstruct pedestrian or vehicular pathways), pedestrian and bicycle safety compliance-related requirements (e.g., requirements related to the maintenance and accessibility of sidewalks, crosswalks, and bike paths to ensure compliance with public safety regulations and disability accommodation laws), and emergency response and disaster preparedness requirements (e.g., requirements related to maintain contingency plans for natural disasters, extreme weather events, and other emergencies that may impact infrastructure stability and public safety, such as debris clearance protocols, flood zone monitoring, and structural integrity assessments following seismic events or other environmental hazards).

Examples of contractual obligations for the local governing entities and/or the contractors, include but are not limited to, responsibilities for local governing entities and/or the contractors (e.g., timing related responsibilities, monitoring and reporting related responsibilities, compliance-related responsibilities for the contractors (e.g., adherence to internal and external governmental requirements and/or other prerequisites or obligations outlined in the SLA, such as regulatory and infrastructure-related requirements and safety-related requirements, etc.), compliance-related responsibilities for the contractors (e.g., adherence to internal and external governmental requirements and/or other prerequisites or obligations outlined in the SLA, access and support related requirements, payment related requirements, etc.), standards or requirements associated with each identified responsibility, performance metrics for the contractors, and remedies and penalties for the contractors and/or the local governing entities in the event of a violation or breach of one or more contractual obligations identified in an SLA.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A computer-implemented method comprising: obtaining, by an edge device, sensor data associated with an environment; processing, by the edge device, the sensor data using a multimodal machine learning model configured to identify a compliance-related object within the environment and one or more visual indicators associated with the compliance-related object; detecting, by the edge device, a compliance violation associated with the identified compliance-related object based on the identified compliance-related object and the one or more visual indicators; determining, by the edge device, context information associated with the detected compliance violation; generating, by the edge device and based on the detected compliance violation, an evidence package comprising at least a portion of the sensor data associated with the detected compliance violation; and determining, by the edge device, one or more distributed processing operations for the evidence package based on the context information.

Aspect 2. The computer-implemented method of Aspect 1, wherein processing the sensor data comprises utilizing a resource-efficient configuration of the multimodal machine learning model for execution at the edge device.

Aspect 3. The computer-implemented method of Aspect 2, wherein the resource-efficient configuration of the multimodal machine learning model comprises quantizing at least a portion of the multimodal machine learning model to a reduced numerical precision format.

Aspect 4. The computer-implemented method of Aspect 3, wherein the quantized portion comprises at least one of a vision encoder or a text encoder of the multimodal machine learning model.

Aspect 5. The computer-implemented method of any of Aspects 2 to 4, wherein the one or more distributed processing operations comprise: transmitting the evidence package to a remote computing system configured to perform additional context analysis, and wherein the resource-efficient configuration of the multimodal machine learning model executed at the edge device performs contextual analysis at a first level of analysis, and the remote computing system performs the additional contextual analysis at a more detailed level of analysis than the first level of analysis.

Aspect 6. The computer-implemented method of any of Aspects 1 to 5, further comprising: obtaining jurisdiction-specific compliance requirement information associated with the compliance-related object; and determining at least one of severity information and priority information based on the jurisdiction-specific compliance requirement information associated with the compliance-related object, wherein the severity information characterizes a seriousness or potential impact of the detected compliance violation, and wherein the priority information characterizes an urgency or handling order associated with the detected compliance violation.

Aspect 7. The computer-implemented method of Aspect 6, wherein the jurisdiction-specific compliance requirement information includes at least one of rule information or policy information, and wherein the one or more distributed processing operations are further based on at least one of the severity information and the priority information.

Aspect 8. The computer-implemented method of Aspect 7, wherein the jurisdiction-specific compliance requirement information identifies and characterizes at least one of asset criticality classifications, response time requirements, reporting obligations, enforcement thresholds, handling preferences associated with compliance-related objects, or a combination thereof.

Aspect 9. The computer-implemented method of any of Aspects 6 to 8, wherein determining the severity information or priority information is further based on at least one of location information associated with the compliance-related object, vehicle information associated with the edge device, or a combination thereof, the vehicle information including at least one of vehicle motion state, vehicle speed, braking state, or operational context.

Aspect 10. The computer-implemented method of any of Aspects 1 to 9, wherein detecting the compliance violation comprises combining visual features extracted from the sensor data with one or more context factors associated with the compliance-related object.

Aspect 11. The computer-implemented method of any of Aspects 1 to 10, wherein processing the sensor data further comprises: determining, based on one or more context factors associated with the environment, a condition associated with the compliance-related object, and detecting the compliance violation based at least in part on the determined condition, wherein the one or more context factors include at least one of environmental conditions, lighting conditions, weather conditions, traffic density, or population density.

Aspect 12. A computing system comprising: at least one memory; and at least one processor coupled to the at least one memory, the at least one processor is configured to perform operations comprising: obtaining, by an edge device, sensor data associated with an environment; processing, by the edge device, the sensor data using a multimodal machine learning model configured to identify a compliance-related object within the environment and one or more visual indicators associated with the compliance-related object; detecting, by the edge device, a compliance violation associated with the identified compliance-related object based on the identified compliance-related object and the one or more visual indicators; determining, by the edge device, context information associated with the detected compliance violation; generating, by the edge device and based on the detected compliance violation, an evidence package comprising at least a portion of the sensor data associated with the detected compliance violation; and determining, by the edge device, one or more distributed processing operations for the evidence package based on the context information.

Aspect 13. The computing system of Aspect 12, wherein processing the sensor data comprises utilizing a resource-efficient configuration of the multimodal machine learning model for execution at the edge device.

Aspect 14. The computing system of Aspect 13, wherein the resource-efficient configuration of the multimodal machine learning model comprises quantizing at least a portion of the multimodal machine learning model to a reduced numerical precision format.

Aspect 15. The computing system of Aspect 14, the quantized portion comprises at least one of a vision encoder or a text encoder of the multimodal machine learning model.

Aspect 16. The computing system of any of Aspects 13 to 15, wherein to determine the one or more distributed processing operations, the at least one processor is configured to perform operations comprising: transmitting the evidence package to a remote computing system configured to perform additional context analysis, and wherein the resource-efficient configuration of the multimodal machine learning model executed at the edge device performs contextual analysis at a first level of analysis, and the remote computing system performs the additional contextual analysis at a more detailed level of analysis than the first level of analysis.

Aspect 17. The computing system of Aspect 16, wherein the at least one processor is configured to perform operations further comprising: obtaining jurisdiction-specific compliance requirement information associated with the compliance-related object; and determining at least one of severity information and priority information based on the jurisdiction-specific compliance requirement information associated with the compliance-related object, wherein the severity information characterizes a seriousness or potential impact of the detected compliance violation, and wherein the priority information characterizes an urgency or handling order associated with the detected compliance violation.

Aspect 18. The computing system of Aspect 17, wherein the jurisdiction-specific compliance requirement information includes at least one of rule information or policy information, and wherein the one or more distributed processing operations are further based on at least one of the severity information and the priority information.

Aspect 19. The computing system of Aspect 18, wherein the jurisdiction-specific compliance requirement information identifies and characterizes at least one of asset criticality classifications, response time requirements, reporting obligations, enforcement thresholds, handling preferences associated with compliance-related objects, or a combination thereof.

Aspect 20. A non-transitory computer-readable medium having instructions stored thereon that, when executed by at least one edge computing device, cause the at least one edge computing device to perform operations comprising: obtaining, by an edge device, sensor data associated with an environment; processing, by the edge device, the sensor data using a multimodal machine learning model configured to identify a compliance-related object within the environment and one or more visual indicators associated with the compliance-related object; detecting, by the edge device, a compliance violation associated with the identified compliance-related object based on the identified compliance-related object and the one or more visual indicators; determining, by the edge device, context information associated with the detected compliance violation; generating, by the edge device and based on the detected compliance violation, an evidence package comprising at least a portion of the sensor data associated with the detected compliance violation; and determining, by the edge device, one or more distributed processing operations for the evidence package based on the context information.

Aspect 21. A computer-implemented method comprising: obtaining, by an edge device, video data generated by one or more optical sensors of the edge device; determining, by the edge device, a compliance violation detection process associated with the video data exceeds a predefined processing threshold; and transmitting, by the edge device and to a cloud server, an evidence package including the video data, the cloud server processes the evidence package to determine the occurrence of a compliance violation.

Aspect 22. The computer-implemented method of Aspect 21, wherein the compliance violation is associated with at least one of a regulatory and infrastructure-related requirements, safety-related requirements, traffic-related requirements or any combination thereof.

Aspect 23. The computer-implemented method of Aspect 21, wherein the compliance violation detection process comprises an object detection process for identifying and recognizing one or more compliance-related objects of interest.

Aspect 24. A computer-implemented method comprising: obtaining, by an edge device, video data generated by one or more optical sensors of the edge device; determining, by the edge device, a compliance violation detection process associated with the video data does not exceed a predefined processing threshold; executing, by the edge device, the compliance violation detection process, the compliance violation detection process including generating an evidence package based on the video data, the evidence package including one or more portions of the video data associated with a compliance violation; determining, by the edge device, a context analysis process associated with the video data does exceed a predefined processing threshold; and transmitting, by the edge device and to a cloud server, the evidence package, the cloud server executes the context analysis process and the context analysis process includes determining context information associated with the compliance violation based on the evidence package.

Aspect 25. A computer-implemented method comprising: obtaining, by an edge device, video data generated by one or more optical sensors of the edge device; determining, by the edge device, a compliance violation detection process associated with the video data does not exceed a predefined processing threshold; executing, by the edge device, the compliance violation detection process, the compliance violation detection process including generating an evidence package based on the video data, the evidence package including one or more portions of the video data associated with a compliance violation; determining, by the edge device, a context analysis process associated with the video data does not exceed a predefined processing threshold; executing, by the edge device, the context analysis process, the context analysis process includes determining context information associated with the compliance violation based on the evidence package; generating content based on the context information; and transmitting, by the edge device and to a cloud server, context data, the context data including the context information and the content, cloud server generates one or more notifications based on the context data.

Aspect 26. A computer-implemented method comprising: obtaining a set of images associated with an object of interest; generating, by a first model, a plurality of synthetic images of the objects of interest, wherein the synthetic images depict the objects of interest across varying scales, orientations, lighting conditions, occlusion levels, and environmental contexts; training a second model based on the synthetic images, the second model is associated with object detection; evaluating the performance of the second model with respect to detecting the object of interest at varying scales; and deploying the evaluated second model on an edge device to detect the object of interest within video data captured by the edge device.

1. A computer-implemented method comprising:
obtaining, by an edge device, sensor data associated with an environment;
processing, by the edge device, the sensor data using a multimodal machine learning model comprising a vision encoder configured to generate visual feature embeddings from the sensor data and a text encoder configured to generate text embeddings from domain-specific semantic prompts, wherein the multimodal machine learning model is configured to identify a compliance-related object within the environment and one or more visual indicators associated with the compliance-related object based on alignment between the visual feature embeddings and the text embeddings;
detecting, by the edge device, a compliance violation associated with the identified compliance-related object based at least in part on the alignment between the visual feature embeddings and the text embeddings;
determining, by the edge device, context information associated with the detected compliance violation based at least in part on alignment between the visual feature embeddings and the text embeddings;
determining, by the edge device, severity information and priority information associated with the detected compliance violation based on the context information, wherein the severity information characterizes a seriousness or potential impact of the detected compliance violation, and wherein the priority information characterizes an urgency or handling order associated with the detected compliance violation;
generating, by the edge device and based on the detected compliance violation, an evidence package comprising at least a portion of the sensor data associated with the detected compliance violation; and
determining, by the edge device, one or more distributed processing operations for the evidence package based on the context information and the severity information and priority information, wherein the one or more distributed processing operations define at least one of, transmission of the evidence package to a remote computing system for additional contextual analysis, deferral of the transmission of the evidence package for later processing, or local retention of the evidence package at the edge device.

2. The computer-implemented method of claim 1, wherein processing the sensor data comprises utilizing a resource-efficient configuration of the multimodal machine learning model for execution at the edge device, and wherein the resource-efficient configuration of the multimodal machine learning model executed at the edge device performs contextual analysis at a first level of analysis, and the remote computing system performs the additional contextual analysis at a more detailed level of analysis than the first level of analysis.

3. The computer-implemented method of claim 2, wherein the resource-efficient configuration of the multimodal machine learning model comprises quantizing at least a portion of the multimodal machine learning model to a reduced numerical precision format.

4. The computer-implemented method of claim 3, wherein the domain-specific semantic prompts are generated form policy information or rule information defining compliance-related object types, condition descriptors, and contextual modifiers associated with the compliance-related object, and wherein the text encoder generates the text embeddings to represent semantic conditions of the compliance-related object rather than to extract or recognize textual content appearing within the sensor data.

5. The computer-implemented method of claim 1, wherein
the multimodal machine learning model determines the one or more visual indicators associated with the compliance-related object based on learned multimodal semantic relationships between the visual feature embeddings and the text embeddings, without applying predefined threshold conditions or deterministic rule-based logic specifying how particular visual conditions of the compliance-related object are to be interpreted.

6. The computer-implemented method of claim 1, further comprising:
obtaining jurisdiction-specific compliance requirement information associated with the compliance-related object; and
determining at least one of severity information and priority information based on the jurisdiction-specific compliance requirement information associated with the compliance-related object,
wherein the severity information characterizes a seriousness or potential impact of the detected compliance violation, and
wherein the priority information characterizes an urgency or handling order associated with the detected compliance violation.

7. The computer-implemented method of claim 6, wherein the jurisdiction-specific compliance requirement information includes at least one of rule information or policy information, and wherein the one or more distributed processing operations are further based on at least one of the severity information and the priority information.

8. The computer-implemented method of claim 7, wherein the jurisdiction-specific compliance requirement information identifies and characterizes at least one of asset criticality classifications, response time requirements, reporting obligations, enforcement thresholds, handling preferences associated with compliance-related objects, or a combination thereof.

9. The computer-implemented method of claim 6, wherein determining the severity information or priority information is further based on at least one of location information associated with the compliance-related object, vehicle information associated with the edge device, or a combination thereof, the vehicle information including at least one of vehicle motion state, vehicle speed, braking state, or operational context.

10. The computer-implemented method of claim 1, wherein detecting the compliance violation comprises combining visual features extracted from the sensor data with one or more context factors associated with the compliance-related object.

11. The computer-implemented method of claim 1, wherein processing the sensor data further comprises:
determining, based on one or more context factors associated with the environment, a condition associated with the compliance-related object, and
detecting the compliance violation based at least in part on the determined condition,
wherein the one or more context factors include at least one of environmental conditions, lighting conditions, weather conditions, traffic density, or population density.

12. A computing system comprising:
at least one memory; and
at least one processor coupled to the at least one memory, the at least one processor is configured to perform operations comprising:
obtaining, by an edge device, sensor data associated with an environment;
processing, by the edge device, the sensor data using a multimodal machine learning model comprising a vision encoder configured to generate visual feature embeddings from the sensor data and a text encoder configured to generate text embeddings from domain-specific semantic prompts, wherein the multimodal machine learning model is configured to identify a compliance-related object within the environment and one or more visual indicators associated with the compliance-related object based on alignment between the visual feature embeddings and the text embeddings;
detecting, by the edge device, a compliance violation associated with the identified compliance-related object based at least in part on the alignment between the visual feature embeddings and the text embeddings;
determining, by the edge device, context information associated with the detected compliance violation based at least in part on alignment between the visual feature embeddings and the text embeddings;
determining, by the edge device, severity information and priority information associated with the detected compliance violation based on the context information, wherein the severity information characterizes a seriousness or potential impact of the detected compliance violation, and wherein the priority information characterizes an urgency or handling order associated with the detected compliance violation;
generating, by the edge device and based on the detected compliance violation, an evidence package comprising at least a portion of the sensor data associated with the detected compliance violation; and
determining, by the edge device, one or more distributed processing operations for the evidence package based on the context information and the severity information and priority information, wherein the one or more distributed processing operations define at least one of, the transmission of the evidence package to a remote computing system for additional contextual analysis, deferral of transmission of the evidence package for later processing, or local retention of the evidence package at the edge device.

13. The computing system of claim 12, wherein processing the sensor data comprises utilizing a resource-efficient configuration of the multimodal machine learning model for execution at the edge device, and wherein the resource-efficient configuration of the multimodal machine learning model executed at the edge device performs contextual analysis at a first level of analysis, and the remote computing system performs the additional contextual analysis at a more detailed level of analysis than the first level of analysis.

14. The computing system of claim 13, wherein the resource-efficient configuration of the multimodal machine learning model comprises quantizing at least a portion of the multimodal machine learning model to a reduced numerical precision format.

15. The computing system of claim 12, wherein the domain-specific semantic prompts are generated form policy information or rule information defining compliance-related object types, condition descriptors, and contextual modifiers associated with the compliance-related object, and wherein the text encoder generates the text embeddings to represent semantic conditions of the compliance-related object rather than to extract or recognize textual content appearing within the sensor data.

16. The computing system of claim 12, wherein
the multimodal machine learning model determines the one or more visual indicators associated with the compliance-related object based on learned multimodal semantic relationships between the visual feature embeddings and the text embeddings, without applying predefined threshold conditions or deterministic rule-based logic specifying how particular visual conditions of the compliance-related object are to be interpreted.

17. The computing system of claim 12, wherein the at least one processor is configured to perform operations further comprising:
obtaining jurisdiction-specific compliance requirement information associated with the compliance-related object; and
determining at least one of severity information and priority information based on the jurisdiction-specific compliance requirement information associated with the compliance-related object,
wherein the severity information characterizes a seriousness or potential impact of the detected compliance violation, and
wherein the priority information characterizes an urgency or handling order associated with the detected compliance violation.

18. The computing system of claim 17, wherein the jurisdiction-specific compliance requirement information includes at least one of rule information or policy information, and wherein the one or more distributed processing operations are further based on at least one of the severity information and the priority information.

19. The computing system of claim 18, wherein the jurisdiction-specific compliance requirement information identifies and characterizes at least one of asset criticality classifications, response time requirements, reporting obligations, enforcement thresholds, handling preferences associated with compliance-related objects, or a combination thereof.

20. A non-transitory computer-readable medium having instructions stored thereon that, when executed by at least one edge computing device, cause the at least one edge computing device to perform operations comprising:
obtaining sensor data associated with an environment;
processing the sensor data using a multimodal machine learning model comprising a vision encoder configured to generate visual feature embeddings from the sensor data and a text encoder configured to generate text embeddings from domain-specific semantic prompts, wherein the multimodal machine learning model is configured to identify a compliance-related object within the environment and one or more visual indicators associated with the compliance-related object based on alignment between the visual feature embeddings and the text embeddings;
detecting a compliance violation associated with the identified compliance-related object based at least in part on the alignment between the visual feature embeddings and the text embeddings;
determining context information associated with the detected compliance violation based at least in part on alignment between the visual feature embeddings and the text embeddings;
determining severity information and priority information associated with the detected compliance violation based on the context information, wherein the severity information characterizes a seriousness or potential impact of the detected compliance violation, and wherein the priority information characterizes an urgency or handling order associated with the detected compliance violation;
generating, by the edge device and based on the detected compliance violation, an evidence package comprising at least a portion of the sensor data associated with the detected compliance violation; and
determining, by the edge device, one or more distributed processing operations for the evidence package based on the context information and the severity information and priority information, wherein the one or more distributed processing operations define at least one of, transmission of the evidence package to a remote computing system for additional contextual analysis, deferral of the transmission of the evidence package for later processing, or local retention of the evidence package at the edge device.
